(19) United States
(12) Patent Application Publication
(10) Pub. No.: US 2004/0135436 A1
(43) Pub. Date: Jul. 15, 2004

(54) Power controller system and method

(76) Inventors: Mark G. Gilbreth, Woodland Hills, CA (US); Joel B. Wacknov, Westlake, CA (US); Simon R. Wall, Faversham (GB)

Correspondence Address: STERNE, KESSLER, GOLDSTEIN & FOX PLLC, 1100 NEW YORK AVENUE, N.W., WASHINGTON, DC, 20005, US

(21) Appl. No.: 10/677,480

(22) Filed: Oct. 3, 2003

Related U.S. Application Data
(63) Continuation of application No. 10/303,051, filed on Nov. 25, 2002, now abandoned.
Application No. 10/303,051 is a continuation-in-part of application No. 09/207,817, filed on Dec. 8, 1998, now Pat. No. 6,487,096.
(60) Provisional application No. 60/080,457, filed on Apr. 2, 1998.

(51) Int. Cl. H02J 1/10

(52) U.S. Cl. 307/18

(57) ABSTRACT

A power controller provides a distributed generation power networking system in which bi-directional power converters are used with a common DC bus for permitting compatibility between various energy components. Each power converter operates essentially as a customized bi-directional switching converter configured, under the control of the power controller, to provide an interface for a specific energy component to the DC bus. The power controller controls the way in which each energy component, at any moment, will sink or source power, and the manner in which the DC bus is regulated. In this way, various energy components can be used to supply, store and/or use power in an efficient manner. The various energy components include energy sources, loads, storage devices and combinations thereof.

### RELATED APPLICATIONS

This application is a continuation of U.S. patent application Ser. No. 10/303,051, filed Nov. 25, 2003, which is a continuation-in-part of U.S. patent application Ser. No. 09/207,817, filed Dec. 8, 1998, (now U.S. Pat. No. 6,487,096), which claims the benefit of U.S. Provisional Application No. 60/080,457, filed Apr. 2, 1998, each of which is incorporated herein by reference in its entirety.

### FIELD OF THE INVENTION

This invention relates generally to power generation, distribution and processing systems and in particular to distributed power generation and distribution power systems using power controllers.

### BACKGROUND OF THE INVENTION

Conventional power generation and distribution systems are configured to maximize the specific hardware used. In the case of a turbine power motor conventional turbogenerator, for example, the output or bus voltage in a conventional power distribution system varies with the speed of the turbine engine. In such systems, the turbine speed must be regulated to control the output or bus voltage. Consequently, the turbine engine cannot be run too low in speed else the bus voltage would not be high enough to generate some of the voltages that are needed. As a result, the turbine engine would have to be run at higher speeds and lower temperatures, making it less efficient.

What is needed therefore is a power generation and distribution system where the bus voltage is regulated by a bi-directional controller independent of turbine speed without the limitations of conventional systems.

### SUMMARY OF THE INVENTION

The present invention provides in a first aspect, a power controller which provides a distributed generation power networking system in which bi-directional power converters are used with a common DC bus for permitting compatibility between various energy components. Each power converter operates essentially as a customized bi-directional switching converter configured, under the control of the power controller, to provide an interface for a specific energy component to the DC bus. The power controller controls the way in which each energy component, at any moment, will sink or source power, and the manner in which the DC bus is regulated. In this way, various energy components can be used to supply, store and/or use power in an efficient manner. The various energy components include energy sources, loads, storage. devices and combinations thereof.

In another aspect, the present invention provides a turbine system including a turbine engine, a load, a power controller, an energy reservoir for providing transient power to the DC bus and an energy reservoir controller, in communication with the power controller, for providing control to the energy reservoir. The power controller includes an engine power conversion in communication with the turbine engine, a utility power conversion in communication with the load and a DC bus.

A turbogenerator system is disclosed including a turbogenerator, a DC output bus for providing power to a load, and a bi-directional motor/generator power converter connected between the turbogenerator and the DC bus to automatically control turbogenerator speed. The turbogenerator system may also include a fuel control system which automatically controls turbogenerator temperature, an output power converter connected between the DC bus and the load for automatically controlling DC bus voltage, an energy reservoir, and a brake resistor for automatically controlling DC bus voltage.

A turbogenerator system is disclosed including a turbogenerator, a DC output bus for providing power to a load, a bi-directional motor/generator power converter connected between the turbogenerator and the DC bus to automatically control turbogenerator speed, and a fuel control system for automatically controlling turbogenerator temperature.

A turbogenerator system is disclosed including a turbogenerator, a DC output bus for providing power to a load, a bi-directional motor/generator power converter connected between the turbogenerator and the DC bus to automatically control turbogenerator speed, a bi-directional output power converter connected between the DC bus and the load for automatically controlling DC bus voltage, and a fuel control system for providing fuel to the turbogenerator for automatically controlling turbogenerator temperature.

A turbogenerator system is disclosed including a turbogenerator, a DC output bus for providing power to a load, a bi-directional motor/generator power converter connected between the turbogenerator and the DC bus, a bi-directional output power converter connected between the DC bus and the load, a fuel control system for providing fuel to the turbogenerator, and a power controller operating the bi-directional motor/generator and output power converter, and the fuel control system, for automatically controlling turbogenerator temperature, turbogenerator speed, and a DC bus voltage. The power controller may independently control turbogenerator speed and temperature and/or DC bus voltage.

These and other features and advantages of this invention will become further apparent from the detailed description and accompanying figures that follow. In the figures and description, numerals indicate the various features of the invention, like numerals referring to like features throughout both the drawing figures and the written description.

### BRIEF DESCRIPTION OF THE DRAWINGS

FIG. 1A is perspective view, partially in section, of an integrated turbogenerator system.

FIG. 1B is a magnified perspective view, partially in section, of the motor/generator portion of the integrated turbogenerator of FIG. 1A.

FIG. 1C is an end view, from the motor/generator end, of the integrated turbogenerator of FIG. 1A.

FIG. 1D is a magnified perspective view, partially in section, of the combustor-turbine exhaust portion of the integrated turbogenerator of FIG. 1A.

FIG. 1E is a magnified perspective view, partially in section, of the compressor-turbine portion of the integrated turbogenerator of FIG. 1A.

FIG. 2 is a block diagram schematic of a turbogenerator system including a power controller having decoupled rotor speed, operating temperature, and DC bus voltage control loops.

FIG. 3 is a block diagram of a power controller used in a power generation and distribution system according to the present invention.

FIG. 4 is a detailed block diagram of a bi-directional power converter in the power controller.

FIG. 5 is a simplified block diagram of a turbineturbogenerator system including the power architecture of the power controller.

FIG. 6 is a block diagram of the power architecture of a typical implementation of the power generation and distribution system, including power controller.

FIG. 7 is a schematic diagram of the internal power architecture of the power controller.

FIG. 8 is a functional block diagram of a power controller interface between a load/utility grid and a turbine turbogenerator using the power controller according to the present invention.

FIG. 9 is a functional block diagram of a power controller interface between a load/utility grid and a turbine turbogenerator using the power controller for a stand-alone application according to the present invention.

FIG. 10 is a schematic diagram of a power controller interface between a load/utility grid and turbine a turbogenerator using the power controller according to the present invention.

FIG. 11 is a block diagram of the software logic architecture for the power controller including external interfaces.

FIG. 12 is a block diagram of an EGT control mode loop for regulating the temperature of the turbineturbogenerator by operation of fuel control system.

FIG. 13 is a block diagram of a speed control mode loop for regulating the rotating speed of the turbineturbogenerator by operation of fuel control system.

FIG. 14 is a block diagram of a power control mode loop for regulating the power producing potential of the turbineturbogenerator.

FIG. 15 is a state diagram showing various operating states of the power controller.

FIG. 16 is a block diagram of the power controller interfacing with a turbine turbogenerator and fuel control system device.

FIG. 17 is a block diagram of thee power controllers in multi-pack configuration.

FIG. 18 is a block diagram of a utility grid analysis system for the power controller according to the present invention.

FIG. 19 is a graph of voltage against time for the utility grid analysis system.

FIG. 20 is a diagram of the power controller including brake resistor and brake resistor modulation switch.

### DETAILED DESCRIPTION OF THE PREFERRED EMBODIMENT(S)

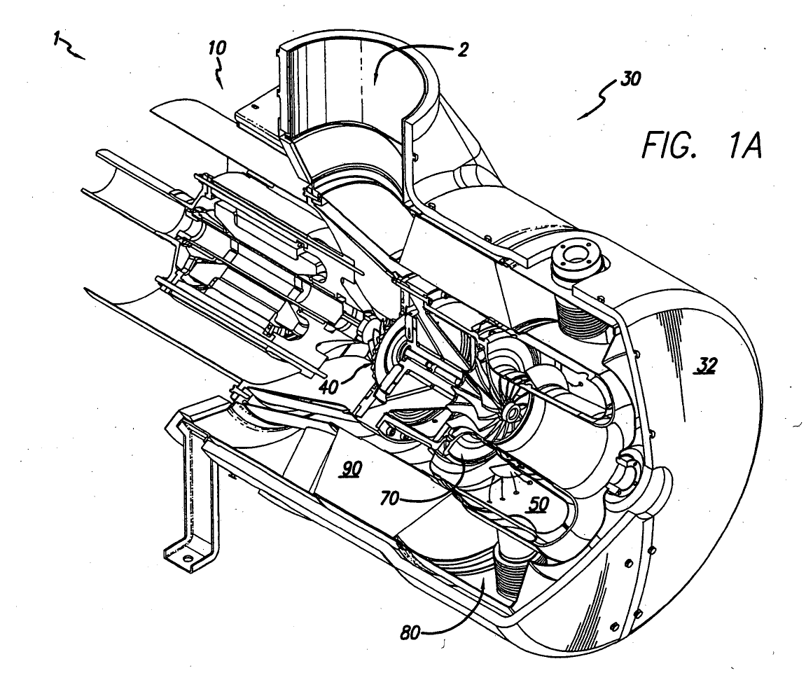

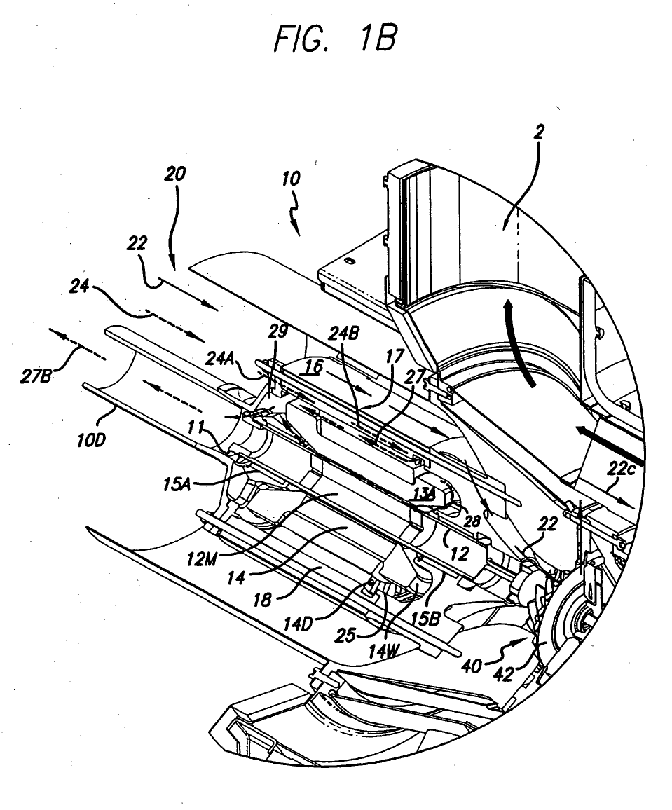

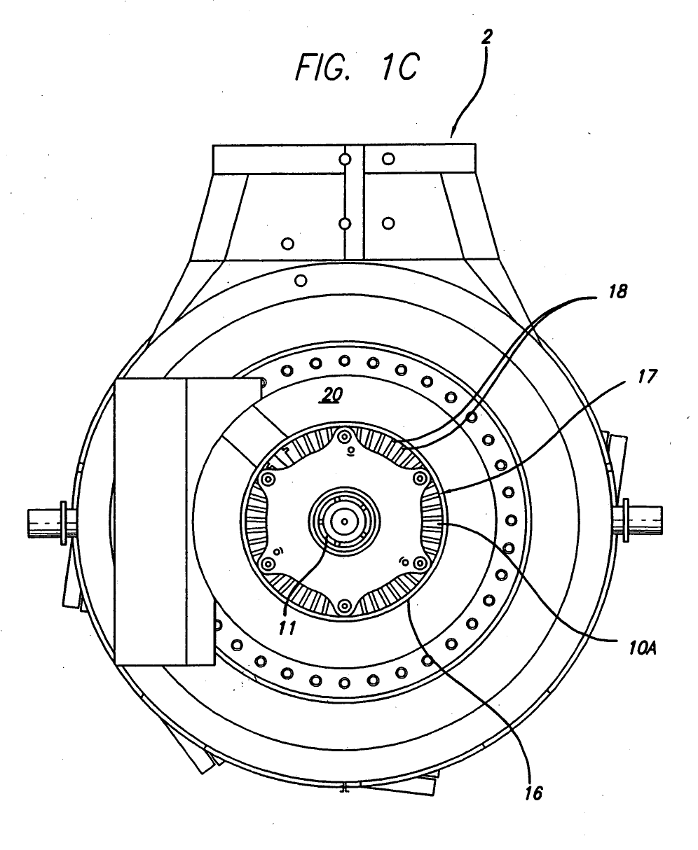

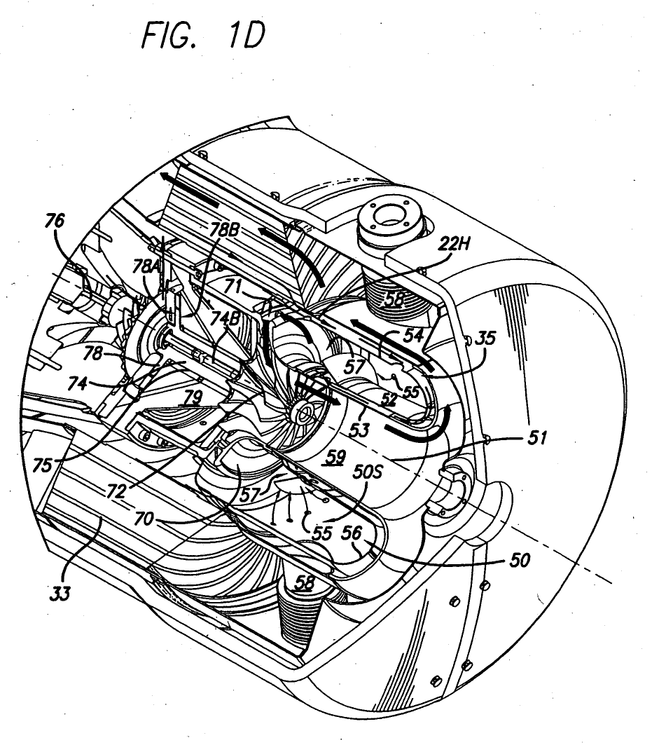

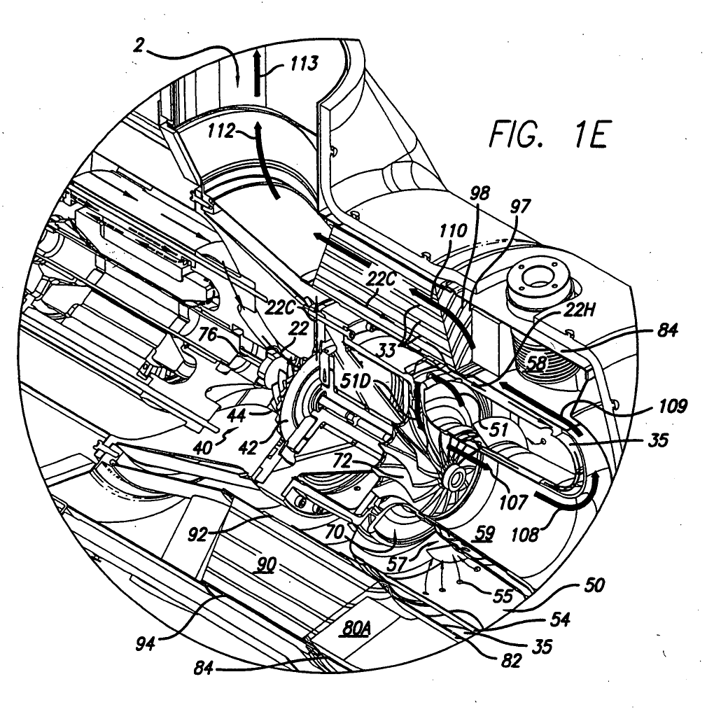

With reference to FIG. 1A, an integrated turbogenerator 1 according to the present

Referring now to FIG. 1B and FIG. 1C, in a currently preferred embodiment of the present disclosure, motor/generator section 10 may be a permanent magnet motor generator having a permanent magnet rotor or sleeve 12. Any other suitable type of motor generator may also be used. Permanent magnet rotor or sleeve 12 may contain a permanent magnet 12M. Permanent magnet rotor or sleeve 12 and the permanent magnet disposed therein are rotatably supported within permanent magnet motor/generator stator 14. Preferably, one or more compliant foil, fluid film, radial, or journal bearings 15A and 15B rotatably support permanent magnet rotor or sleeve 12 and the permanent magnet disposed therein. All bearings, thrust, radial or journal bearings, in turbogenerator 1 may be fluid film bearings or compliant foil bearings. Motor/generator housing 16 encloses stator heat exchanger 17 having a plurality of radially extending stator cooling fins 18. Stator cooling fins 18 connect to or form part of stator 14 and extend into annular space 10A between motor/generator housing 16 and stator 14. Wire windings 14W exist on permanent magnet motor/generator stator 14.

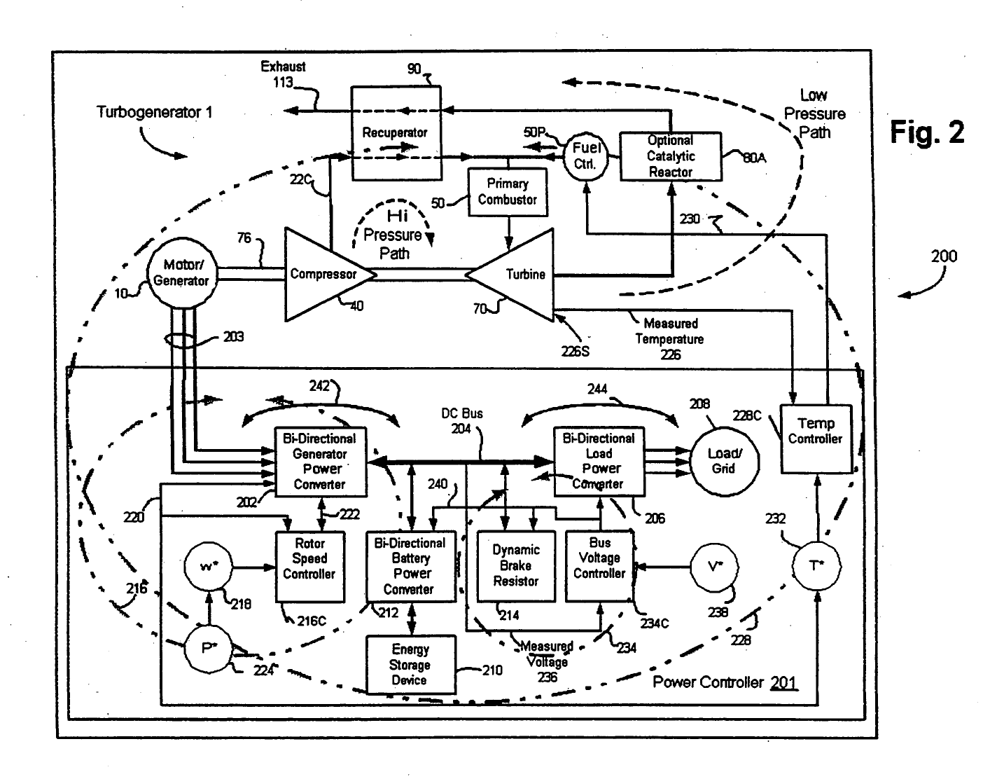

Referring now to FIG. 1D, combustor 50 may include cylindrical inner wall 52 and cylindrical outer wall 54. Cylindrical outer wall 54 may also include air inlets 55. Cylindrical walls 52 and 54 define an annular interior space 50S in combustor 50 defining an axis 50A. Combustor 50 includes a generally annular wall 56 further defining one axial end of the annular interior space of combustor 50. Associated with combustor 50 may be one or more fuel injector inlets 58 to accommodate fuel injectors which receive fuel from fuel control element 50P as shown in FIG. 2, and inject fuel or a fuel air mixture to interior of 50S combustor 50. Inner cylindrical surface 53 is interior to cylindrical inner wall 52 and forms exhaust duct 59 for turbine 70.

Turbine 70 may include turbine wheel 72. An end of combustor 50 opposite annular wall 56 further defines an aperture 71 in turbine 70 exposed to turbine wheel 72. Bearing rotor 74 may include a radially extending thrust bearing portion, bearing rotor thrust disk 78, constrained by bilateral thrust bearings 78A and 78B. Bearing rotor 74 may be rotatably supported by one or more journal bearings 75 within center bearing housing 79. Bearing rotor thrust disk 78 at the compressor end of bearing rotor 74 is rotatably supported preferably by a bilateral thrust bearing 78A and 78B. Journal or radial bearing 75 and thrust bearings 78A and 78B may be fluid film or foil bearings.

Turbine wheel 72, bearing rotor 74 and compressor impeller 42 may be mechanically constrained by tie bolt 74B, or other suitable technique, to rotate when turbine wheel 72 rotates. Mechanical link 76 mechanically constrains compressor impeller 42 to permanent magnet rotor or sleeve 12 and the permanent magnet disposed therein causing permanent magnet rotor or sleeve 12 and the permanent magnet disposed therein to rotate when compressor impeller 42 rotates.

Referring now to FIG. 1E, compressor 40 may include compressor impeller 42 and compressor impeller housing 44. Recuperator 90 may have an annular shape defined by cylindrical recuperator inner wall 92 and cylindrical recuperator outer wall 94. Recuperator 90 contains internal passages for gas flow, one set of passages, passages 33 connecting from compressor 40 to combustor 50, and one set of passages, passages 97, connecting from turbine exhaust 80 to turbogenerator exhaust output 2.

Referring again to FIG. 1B and FIG. 1C, in operation, air flows into primary inlet 20 and divides into compressor air 22 and motor/generator cooling air 24. Motor/generator cooling air 24 flows into annular space 10A between motor/generator housing 16 and permanent magnet motor/generator stator 14 along flow path 24A. Heat is exchanged from stator cooling fins 18 to generator cooling air 24 in flow path 24A, thereby cooling stator cooling fins 18 and stator 14 and forming heated air 24B. Warm stator cooling air 24B exits stator heat exchanger 17 into stator cavity 25 where it further divides into stator return cooling air 27 and rotor cooling air 28. Rotor cooling air 28 passes around stator end 13A and travels along rotor or sleeve 12. Stator return cooling air 27 enters one or more cooling ducts 14D and is conducted through stator 14 to provide further cooling. Stator return cooling air 27 and rotor cooling air 28 rejoin in stator cavity 29 and are drawn out of the motor/generator 10 by exhaust fan 11 which is connected to rotor or sleeve 12 and rotates with rotor or sleeve 12. Exhaust air 27B is conducted away from primary air inlet 20 by duct 10D.

Referring again to FIG. 1E, compressor 40 receives compressor air 22. Compressor impeller 42 compresses compressor air 22 and forces compressed gas 22C to flow into a set of passages 33 in recuperator 90 connecting compressor 40 to combustor 50. In passages 33 in recuperator 90, heat is exchanged from walls 98 of recuperator 90 to compressed gas 22C. As shown in FIG. 1E, heated compressed gas 22H flows out of recuperator 90 to space 35 between cylindrical inner surface 82 of turbine exhaust 80 and cylindrical outer wall 54 of combustor 50. Heated compressed gas 22H may flow into combustor 54 through sidewall ports 55 or main inlet 57. Fuel (not shown) may be reacted in combustor 50, converting chemically stored energy to heat. Hot compressed gas 51 in combustor 50 flows through turbine 70 forcing turbine wheel 72 to rotate. Movement of surfaces of turbine wheel 72 away from gas molecules partially cools and decompresses gas 51D moving through turbine 70. Turbine 70 is designed so that exhaust gas 107 flowing from combustor 50 through turbine 70 enters cylindrical passage 59. Partially cooled and decompressed gas in cylindrical passage 59 flows axially in a direction away from permanent magnet motor/generator section 10, and then radially outward, and then axially in a direction toward permanent magnet motor/generator section 10 to passages 97 of recuperator 90, as indicated by gas flow arrows 108 and 109 respectively.

In an alternate embodiment of the present disclosure, low-pressure catalytic reactor 80A may be included between fuel injector inlets 58 and recuperator 90. Low-pressure catalytic reactor 80A may include internal surfaces (not shown) having catalytic material (e.g., Pd or Pt, not shown) disposed on them. Low-pressure catalytic reactor 80A may have a generally annular shape defined by cylindrical inner surface 82 and cylindrical low pressure outer surface 84. Unreacted and incompletely reacted hydrocarbons in gas in low pressure catalytic reactor 80A react to convert chemically stored energy into additional heat, and to lower concentrations of partial reaction products, such as harmful emissions including nitrous oxides (NOx).

Gas 110 flows through passages 97 in recuperator 90 connecting from turbine exhaust 80 or catalytic reactor 80A to turbogenerator exhaust output 2, as indicated by gas flow arrow 112, and then exhausts from turbogenerator 1, as indicated by gas flow arrow 113. Gas flowing through passages 97 in recuperator 90 connecting from turbine exhaust 80 to outside of turbogenerator 1 exchanges heat to walls 98 of recuperator 90. Walls 98 of recuperator 90 heated by gas flowing from turbine exhaust 80 exchange heat to gas 22C flowing in recuperator 90 from compressor 40 to combustor 50.

Turbogenerator 1 may also include various electrical sensor and control lines for providing feedback to power controller 201 and for receiving and implementing control signals as shown in FIG. 2.

Alternative Mechanical Structural Embodiments of the Intergrated Turbogenerator

The integrated turbogenerator disclosed above is exemplary. Several alternative structural embodiments are known.

In one alternative embodiment, air 22 may be replaced by a gaseous fuel mixture. In this embodiment, fuel injectors may not be necessary. This embodiment may include an air and fuel mixer upstream of compressor 40.

In another alternative embodiment, fuel may be conducted directly to compressor 40, for example by a fuel conduit connecting to compressor impeller housing 44. Fuel and air may be mixed by action of the compressor impeller 42. In this embodiment, fuel injectors may not be necessary.

In another alternative embodiment, combustor 50 may be a catalytic combustor.

In still another alternative embodiment, geometric relationships and structures of components may differ from those shown in FIG. 1A. Permanent magnet motor/generator section 10 and compressor/combustor section 30 may have low pressure catalytic reactor 80A outside of annular recuperator 90, and may have recuperator 90 outside of low pressure catalytic reactor 80A. Low-pressure catalytic reactor 80A may be disposed at least partially in cylindrical passage 59, or in a passage of any shape confined by an inner wall of combustor 50. Combustor 50 and low pressure catalytic reactor 80A may be substantially or completely enclosed with an interior space formed by a generally annularly shaped recuperator 90, or a recuperator 90 shaped to substantially enclose both combustor 50 and low pressure catalytic reactor 80A on all but one face.

An integrated turbogenerator is a turbogenerator in which the turbine, compressor, and generator are all constrained to rotate based upon rotation of the shaft to which the turbine is connected. The methods and apparatus disclosed herein are preferably but not necessarily used in connection with a turbogenerator, and preferably but not necessarily used in connection with an integrated turbogenerator.

Control System

Referring now to FIG. 2, a preferred embodiment is shown in which a turbogenerator system 200 includes power controller 201 which has three substantially decoupled control loops for controlling (1) rotary speed, (2) temperature, and (3) DC bus voltage. A more detailed description of an appropriate power controller is disclosed in U. S. patent application Ser. No. 09/207,817, filed Dec. 8, 1998 in the names of Gilbreth, Wacknov and Wall, and assigned to the assignee of the present application which is incorporated herein in its entirety by this reference.

Referring still to FIG. 2, turbogenerator system 200 includes integrated turbogenerator 1 and power controller 201. Power controller 201 includes three decoupled or independent control loops.

A first control loop, temperature control loop 228, regulates a temperature related to the desired operating temperature of primary combustor 50 to a set point, by varying fuel flow from fuel control element 50P to primary combustor 50. Temperature controller 228C receives a temperature set point, T*, from temperature set point source 232, and receives a measured temperature from temperature sensor 226S connected to measured temperature line 226. Temperature controller 228C generates and transmits over fuel control signal line 230 to fuel pump 50P a fuel control signal for controlling the amount of fuel supplied by fuel pump 50P to primary combustor 50 to an amount intended to result in a desired operating temperature in primary combustor 50. Temperature sensor 226S may directly measure the temperature in primary combustor 50 or may measure a temperature of an element or area from which the temperature in the primary combustor 50 may be inferred.

A second control loop, speed control loop 216 controls speed of the shaft common to the turbine 70, compressor 40, and motor/generator 10, hereafter referred to as the common shaft, by varying torque applied by the motor generator to the common shaft. Torque applied by the motor generator to the common shaft depends upon power or current drawn from or pumped into windings of motor/generator 10. Bi-directional generator power converter 202 is controlled by rotor speed controller 216C to transmit power or current in or out of motor/generator 10, as indicated by bi-directional arrow 242. A sensor in turbogenerator 1 senses the rotary speed on the common shaft and transmits that rotary speed signal over measured speed line 220. Rotor speed controller 216 receives the rotary speed signal from measured speed line 220 and a rotary speed set point signal from a rotary speed set point source 218. Rotary speed controller 216C generates and transmits to generator power converter 202 a power conversion control signal on line 222 controlling generator power converter 202's transfer of power or current between AC lines 203 (i.e., from motor/generator 10) and DC bus 204. Rotary speed set point source 218 may convert to,the rotary speed set point a power set point P* received from power set point source 224.

A third control loop, voltage control loop 234, controls bus voltage on DC bus 204 to a set point by transferring power or voltage between DC bus 204 and any of (1) Load/Grid 208 and/or (2) energy storage device 210, and/or (3) by transferring power or voltage from DC bus 204 to dynamic brake resistor 214. A sensor measures voltage DC bus 204 and transmits a measured voltage signal over measured voltage line 236. Bus voltage controller 234C receives the measured voltage signal from voltage line 236 and a voltage set point signal V* from voltage set point source 238. Bus voltage controller 234C generates and transmits signals to bi-directional load power converter 206 and bi-directional battery power converter 212 controlling their transmission of power or voltage between DC bus 204, load/grid 208, and energy storage device 210, respectively. In addition, bus voltage controller 234 transmits a control signal to control connection of dynamic brake resistor 214 to DC bus 204.

Power controller 201 regulates temperature to a set point by varying fuel flow, adds or removes power or current to motor/generator 10 under control of generator power converter 202 to control rotor speed to a set point as indicated by bi-directional arrow 242, and controls bus voltage to a set point by (1) applying or removing power from DC bus 204 under the control of load power converter 206 as indicated by bi-directional arrow 244, (2) applying or removing power from energy storage device 210 under the control of battery power converter 212, and (3) by removing power from DC bus 204 by modulating the connection of dynamic brake resistor 214 to DC bus 204.

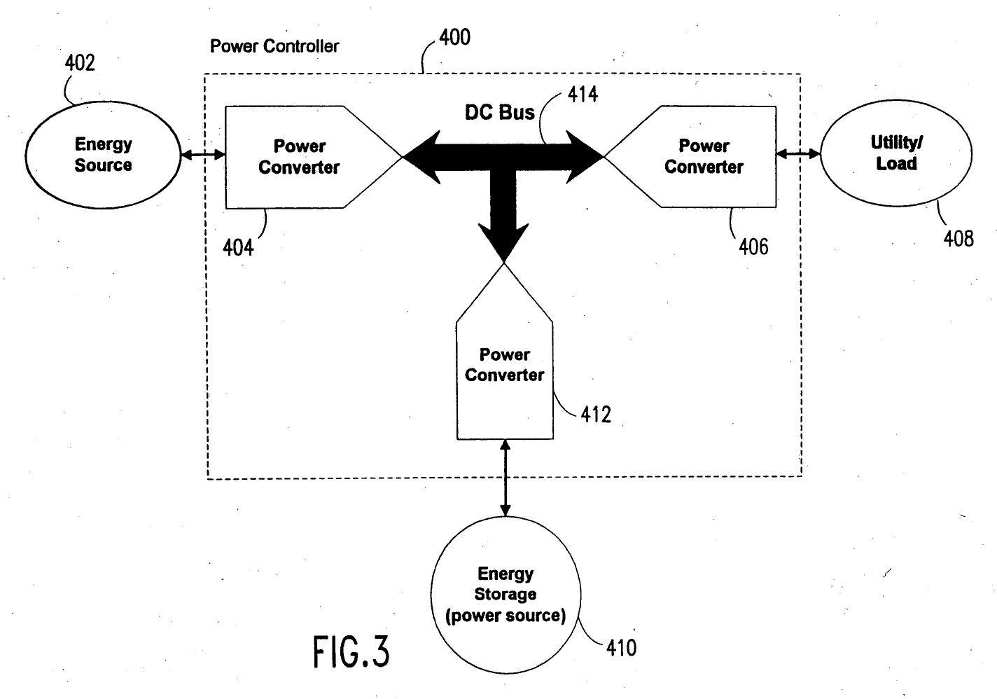

Referring to FIG.3, power controller 400 includes bi-directional, reconfigurable, power converters 404, 406 and 412 used with common DC bus 414 for permitting compatibility between one or more energy components 402, 408 and/or 410. Each power converter 404, 406 and 412 operates essentially as a customized, bi-directional switching converter configured, under the control of power controller 400, to provide an interface for a specific energy component 402, 408 or 410 to DC bus 414. Power controller 400 controls the way in which each energy component 402, 408 or 410, at any moment, will sink or source power, and the manner in which DC bus 414 is regulated. In this way, various energy components can be used to supply, store and/or use power in an efficient manner.

Energy source 402 may be a turbogenerator system such as a microturbine, photovoltaics, wind turbine or any other conventional or newly developed source. Energy storage/power source 410 may be a flywheel, battery, ultracap or any other conventional or newly considered energy storage device. Utility/load 408 may be a utility grid, DC load, drive motor or any other conventional or newly developed utility/load 408.

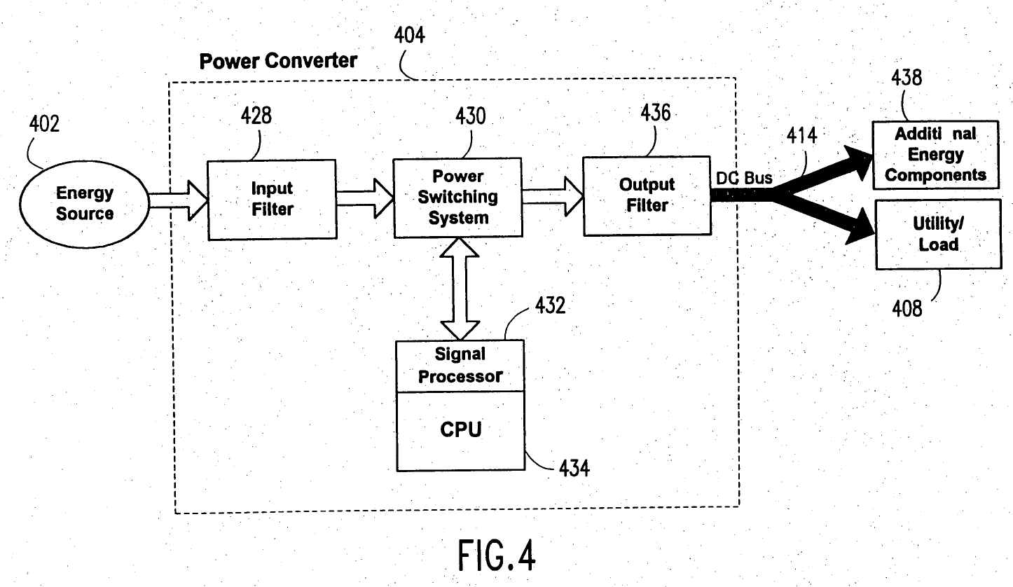

Referring now also to FIG. 4, a detailed block diagram of bi-directional power converter 404 shown in FIG. 3, is illustrated. Energy source 402 is connected to DC bus 414 via power converter 404. Energy source 402 may be, for example, a turbogenerator including a turbine engine driving a motor/generator to produce AC which is applied to power converter 404. DC bus 414 connects power converter 404 to utility/load 408 and additional energy components 438. Power converter 404 includes input filter 428, power switching system 430, output filter 436, signal processor 432 and main CPU 434. In operation, energy source 402 applies AC to input filter 428 in power converter 404. The filtered AC is then applied to power switching system 430 which may conveniently include a series of insulated gate bipolar transistor (IGBT) switches operating under the control of signal processor (SP) 432 which is controlled by main CPU 434. Other conventional or newly developed switches may be utilized as well. The output of the power switching system 430 is applied to output filter 436 which then applies the filtered DC to DC bus 414.

In accordance with the present invention, each power converter 404, 406 and 412 operates essentially as a customized, bi-directional switching converter under the control of main CPU 434, which uses SP 432 to perform its operations. Main CPU 434 provides both local control and sufficient intelligence to form a distributed processing system. Each power converter 404, 406 and 412 is tailored to provide an interface for a specific energy component to DC bus 414.

Main CPU 434 controls the way in which each energy component 402, 408 and 410 sinks or sources power, and the way in which DC bus 414 is regulated at any time. In particular, main CPU 434 reconfigures the power converters 404, 406 and 412 into different configurations for different modes of operation. In this way, various energy components 402, 408 and 410 can be used to supply, store and/or use power in an efficient manner.

In the case of a turbogenerator, for example, power controller 400 may regulate bus voltage independently of turbogenerator speed.

FIG. 3 shows a system topography in which DC bus 414, which may be regulated at 800 v DC for example, is at the center of a star pattern network. In general, energy source 402 provides power to DC bus 414 via bi-directional power converter 404 during normal power generation mode. Similarly, during normal power generation mode, power converter 406 converts the power on DC bus 414 to the form required by utility/load 408, which may be any type of load including a utility web or grid. During other modes of operation, such as utility start up, power converters 404 and 406 may be controlled by the main processor to operate in different manners.

For example, energy may be needed during start up to start a prime mover, such as a turbine engine in a turbogenerator included in energy source 402. This energy may come from load/utility grid 408 (during utility start up) or from energy storage/power source 410 (during battery start up), such as a battery, flywheel or ultra-cap.

During utility start up, power converter 406 applies power from utility/load 408 to DC bus 414. Power converter 404 applies power required from DC bus 414 to energy source 402 for startup. During utility start up, a turbine engine of a turbogenerator in energy source 402 may be controlled in a local feedback loop to maintain the turbine engine speed, typically in revolutions per minute (RPM). Energy storage/power source 410, such as a battery, may be disconnected from DC bus 414 while load/utility grid 408 regulates VDC on DC bus 414.

Similarly, in battery start up mode, the power applied to DC bus 414 from which energy source 402 is started may be provided by energy storage/power source 410 which may be a flywheel, battery super capacitor or similar device. Energy storage/power source 410 has its own power conversion circuit in power converter 412, which limits the surge current into DC bus 414 capacitors, and allows enough power to flow to DC bus 414 to start energy source 402. In particular, power converter 406 isolates DC bus 414 so that power converter 404 can provide the required starting power from DC bus 414 to energy source 402.

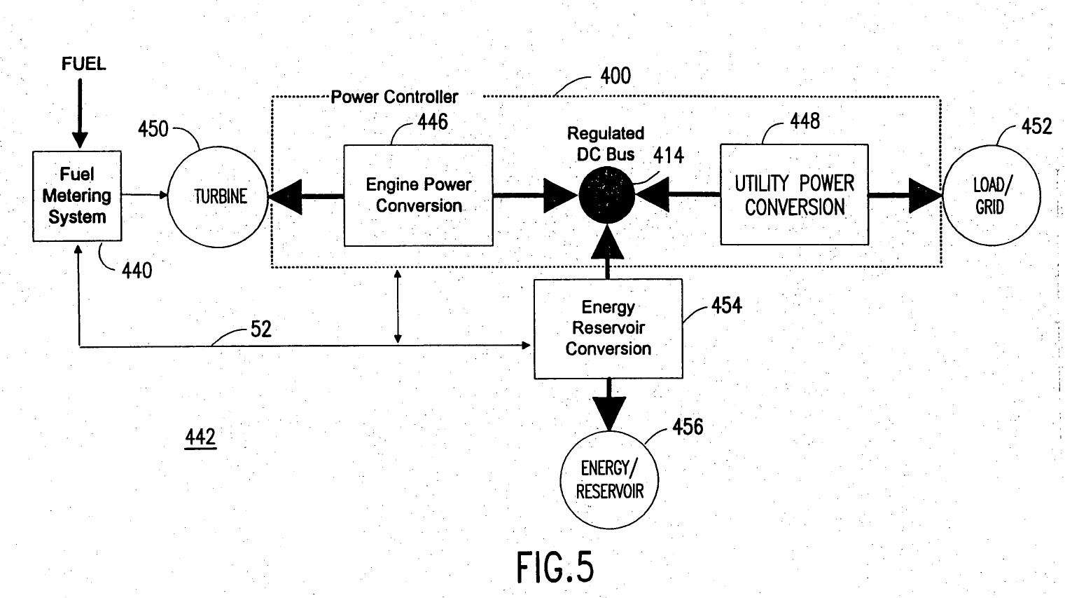

Referring to FIG. 5, a simplified block diagram of turbogenerator system 442 is illustrated. Turbogenerator system 442 includes a fuel metering system 440, turbogenerator 450, power controller 400, energy reservoir conversion process 454, energy reservoir 456 and load/utility grid 452. The fuel metering system 440 is matched to the available fuel and pressure. The power controller 400 converts the electricity from turbogenerator 450 into regulated DC applied to DC bus 414 and then converts the DC power on DC bus 414 to utility grade AC electricity.

By separating the engine control from the power conversion processes, greater control of both processes is realized. All of the interconnections are provided by communications bus and power connection 400.

The power controller 400 includes bi-directional engine power conversion process 446 and bi-directional utility/load or output power conversion process 448 between turbogenerator 450 and the load/utility grid 452. The bi-directional (i.e. reconfigurable) power conversion processes 446 and 448 are used with common regulated DC bus 414 for connection with turbogenerator 450 and load/utility grid 452. Each power conversion process 446 and 448 operates essentially as a customized bi-directional switching conversion process configured, under the control of the power controller 400, to provide an interface for a specific energy component such as turbogenerator 450 or load/utility grid 452 to DC bus 414. The power controller 400 controls the way that each energy component, at any moment, will sink or source power, and the manner in which DC bus 414 is regulated. Both of these power conversion processes 446 and 448 are capable of operating in a forward or reverse direction. This allows starting turbogenerator 450 from either the energy reservoir 456 or the load/utility grid 452. The regulated DC bus 414 allows a standardized interface to energy reservoirs such as batteries, flywheels, and ultra-caps. The architecture disclosed herein permits the use of virtually any technology that can convert its energy to/from electricity.

Since the energy may flow in either direction to or from the energy reservoir 456, transients may be handled by supplying energy or absorbing energy therefrom. Not all systems will need the energy reservoir 456. The energy reservoir 456 and its bi-directional energy reservoir conversion process 454 may be contained inside the power controller 400.

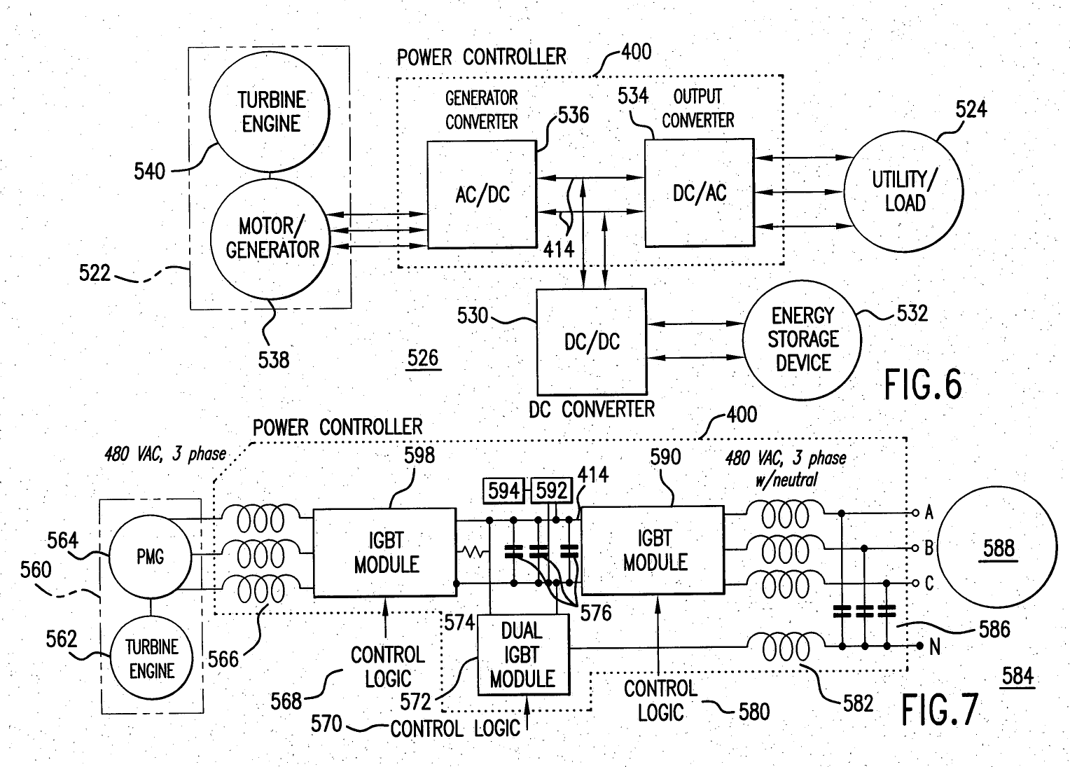

Referring to FIG. 6, a typical implementation of power controller 400 with a turbogenerator 522, including turbine engine 540 and motor/generator 538 is shown. The power controller 400 includes motor/generator converter 536 and output converter 534 between turbogenerator 522 and the load/utility grid 524.

In particular, in the normal power generation mode, the motor/generator converter 536 provides for AC to DC power conversion between motor/generator 538 and DC bus 414 and the output converter 534 provides for DC to AC power conversion between DC bus 414 and load/utility grid 524. Both of these power converters 536 and 534 are capable of operating in a forward or reverse direction. This allows starting turbogenerator 522 by supplying power to motor/generator 538 from either the energy storage device 532 or the load/utility grid 524.

Since the energy may flow in either direction to or from the energy storage device 532, transients may be handled by supplying or absorbing energy therefrom. The energy storage device 532 and its DC converter 530 may not be contained inside the power controller 520. The DC converter 530 provides for DC to DC power conversion.

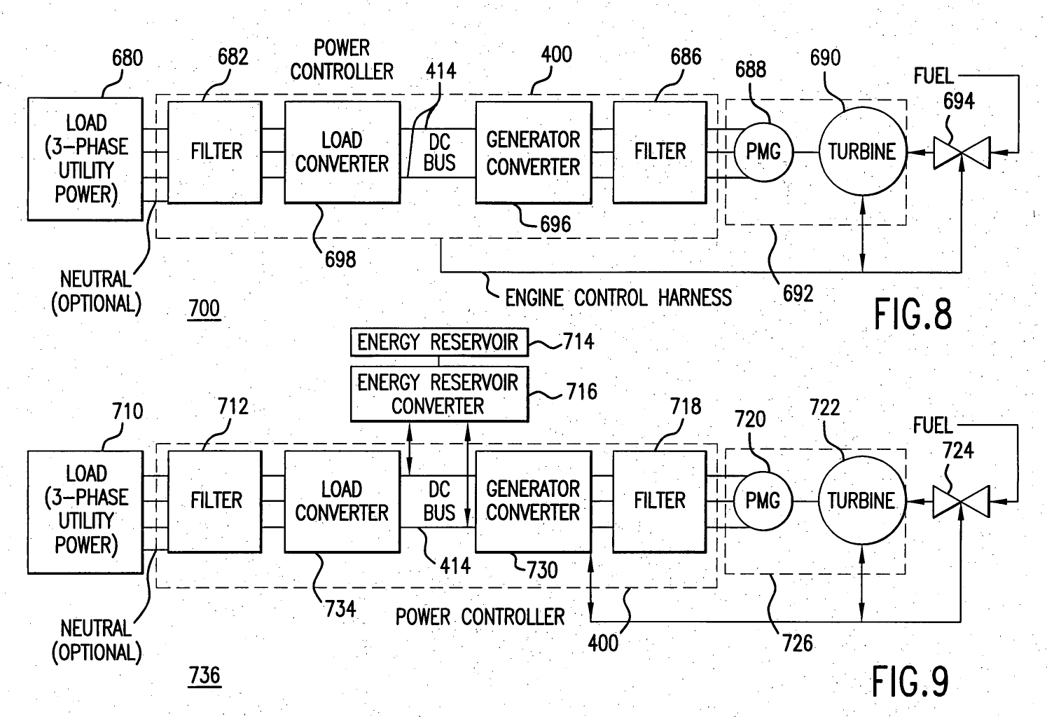

Referring now also to FIG. 7, a partial schematic of a typical internal power architecture of a system as shown in FIG. 6, is shown in greater detail. Turbogenerator 560 includes an integral motor/generator 564, such as a permanent magnet motor/generator (PMG), rotationally coupled to the turbine engine 562 therein that can be used as either a motor (for starting) or a generator (for normal mode of operation). Because all of the controls can be performed in the digital domain and all switching (except for one output contactor such as output contactor 774 shown below in FIG. 8) is done with solid-state switches, it is easy to shift the direction of the power flow as needed. This permits very tight control of the speed of turbine engine 562 during starting and stopping.

In one configuration, the power output may be a 480 VAC, 3-phase output. Other embodiments may be adapted to provide for other power output requirements such as, for example, a 3-phase, 400 VAC, and single-phase in the range of 100 to 260 VAC.

Power controller 596 includes motor/generator converter 598 and output converter 590. Motor/generator converter 598 includes IGBT switches, such as a seven-pack IGBT module driven by control logic 568, providing a variable voltage, variable frequency 3-phase drive to the motor/generator 564 from DC bus 414 during startup. Inductors 566 are utilized to minimize any current surges associated with the high frequency switching components that may affect the motor/generator 564 to increase operating efficiency.

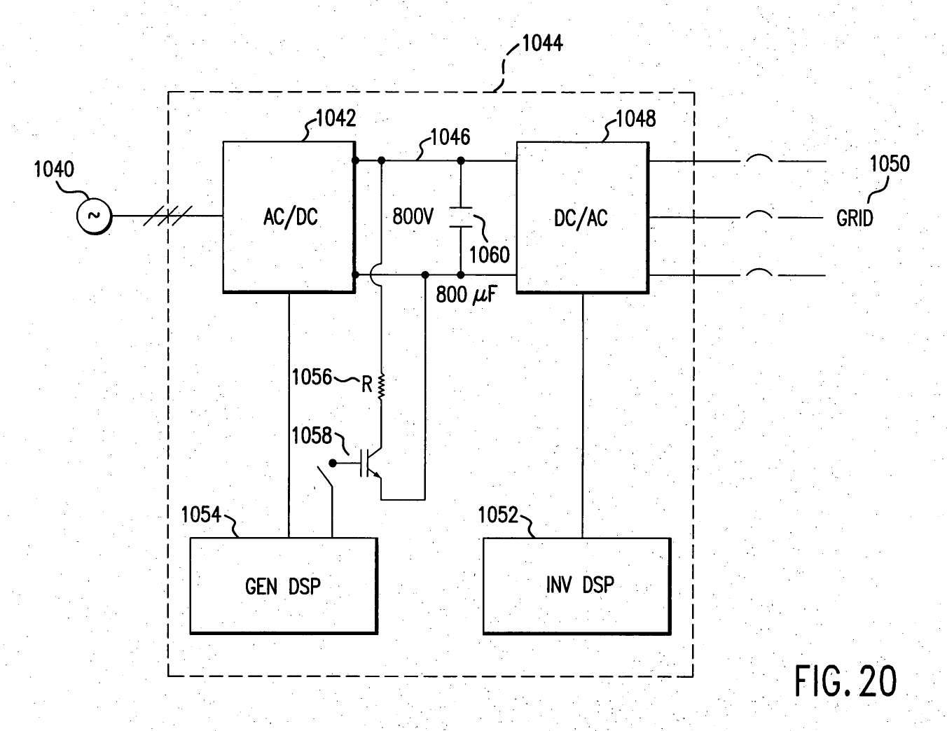

Motor/Generator converter 598 controls motor/generator 564 and the turbine engine 562 of turbogenerator 560. Motor/generator converter 598 incorporates gate driver and fault sensing circuitry as well as a seventh IGBT used as a switch (such as switch 1058 of FIG. 20) to dump power into a resistor (such as brake resistor 1056 of FIG. 20). The gate drive inputs and fault outputs require external isolation. Four external, isolated power supplies are required to power the internal gate drivers. In one embodiment, Motor/generator converter 598 is used in a turbogenerator system that generates 480 VAC at its output terminals delivering power to a freestanding or utility-connected load. During startup and cool down (and occasionally during normal operation), the direction of power flow through motor/generator converter 598 reverses. When the turbine engine of turbogenerator 560 is being started, power is supplied to the DC bus 578 from either an energy reservoir such as a battery (not shown in this figure) or from load/utility grid 588. The DC on DC bus 578 is then converted to variable voltage, variable frequency AC voltage to operate motor/generator 564 as a motor to start the turbine engine 562 in turbogenerator 560.

For utility grid connect operation, control logic 580 sequentially drives solid state IGBT switches, typically configured in a six-pack IGBT module, associated with load or output converter 590 to boost the utility voltage to provide start power to the motor/generator converter 598. In one embodiment, the IGBT switches in load or output converter 590 are operated at a high (15 kHz) frequency, and modulated in a pulse width modulation manner to provide four quadrant power converter operation. Inductors 582 and AC filter capacitors 586 provide a filtered output to the load/grid 588.

In one embodiment, output converter 590 is part of the electronics that controls the converter of the turbine. Output converter 590 incorporates gate driver and fault sensing circuitry. The gate drive inputs and fault outputs require external isolation. Four isolated power supplies may be used to power the internal gate drivers.

After turbogenerator 560 is running, output converter 590 is used to convert the regulated DC bus voltage to the approximately 50 or 60 hertz frequency typically required for utility grade power to supply utility grid/load 588.

When there is no energy reservoir, the energy to power turbogenerator 560 during startup and cool down must come from load/utility grid 588. Under this condition, the direction of power flow through the six-pack IGBT module in output converter 590 reverses. DC bus 578 receives its energy from load/utility grid 588, via the six-pack IGBT module in output converter 590 acting as an AC to DC converter. The DC on bus 578 is then converted to a variable frequency AC voltage by motor/generator converter 598 to operate motor/generator 564 as a motor to start turbogenerator 560. To initially accelerate the turbine engine 562 of turbogenerator 560 as rapidly as possible, current flows at the maximum rate through the seven-pack IGBT module in motor/generator converter 598 and also through the six-pack IGBT module in output converter 590.

Dual IGBT module 572, driven by control logic 570, may also be used to optionally provide neutral to supply 3 phase, 4 wire loads.

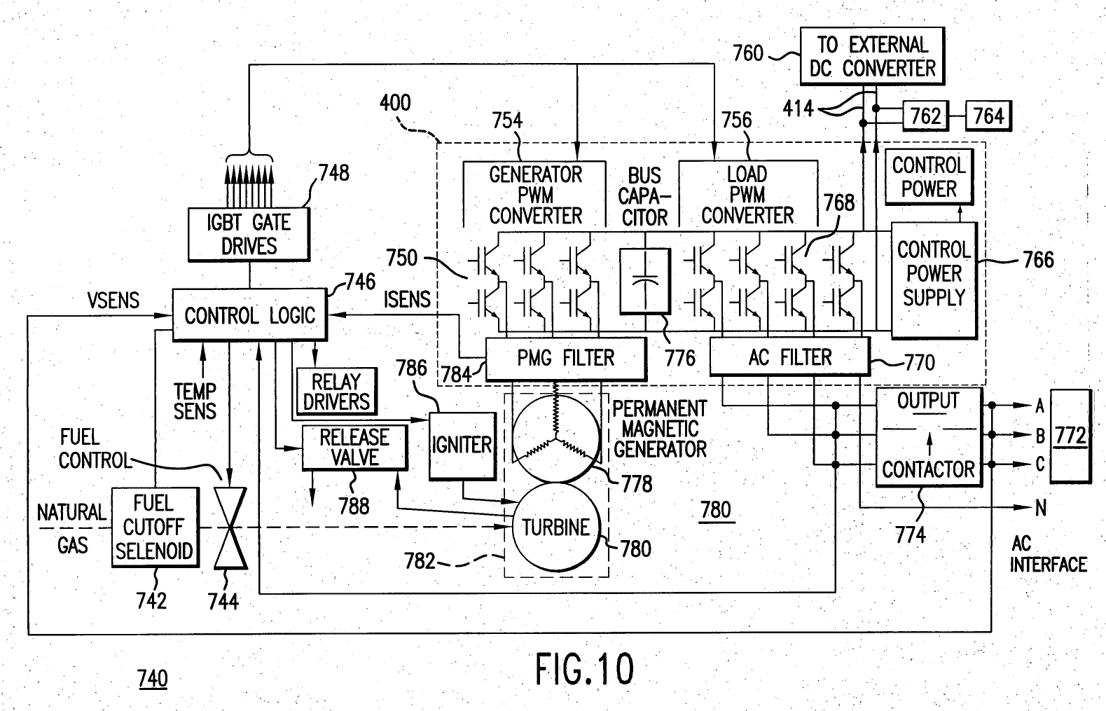

The energy needed to start turbogenerator 560 may come from load/utility grid 588 or from energy reservoir 594, such as a battery, flywheel or ultra-cap. When utility grid 588 supplies the energy, utility grid 588 is connected to power controller 596 through two circuits. First is an output contactor, such as output contactor 774 as shown in FIG. 10, that handles the full power. Second is a “soft-start” or “pre-charge” circuit that supplies limited power (it is current limited to prevent very large surge currents) from utility grid 588 to DC bus 414 through a simple rectifier. The amount of power supplied through the soft-start circuit is enough to start the housekeeping power supply, power the control board, and run the power supplies for the IGBTs, and close the output contactor. When the output contactor closes, the IGBTs are configured to create DC from the AC waveform. Enough power is created to run the fuel metering circuit (744 of FIG. 10), start the engine, and close the various solenoids (including the dump valve on the engine).

When energy reservoir 594 supplies the energy, energy reservoir 594 has its own power conversion circuit, energy reservoir conversion process 592 that limits the surge circuit into DC bus capacitors 576. Energy reservoir 594 allows enough power to flow to DC bus 414 to run fuel-metering circuit (744 of FIG. 10), start turbine engine 562, and close the various solenoids (including the dump valve on turbine engine 562). After turbine engine 562 becomes self-sustaining, the energy reservoir 594 starts to replace the energy used to start turbine engine 562, by drawing power from DC bus 414.

In addition to the sequences described above, power controller 400 senses the presence of other controllers during the initial power up phase. If another controller is detected, the controller must be part of a multi-pack, and proceeds to automatically configure itself for operation as part of a multi-pack.

Referring now to FIG. 8, a fictional block diagram of an interface between load/utility grid 680 and turbogenerator 692, using power controller 400 is shown. In this example, power controller 400 includes filter 682, two bi-directional converters 696 and 698, connected by DC bus 414 and filter 686. Motor/generator converter 696 starts turbine engine 690, using motor/generator 688 as a motor, from utility or battery power. Load or output converter 698 produces AC power using an output from motor/generator converter 696 to draw power from high-speed motor/generator 688. Power controller 400 also regulates fuel to turbine engine 690 via fuel control (744 of FIG. 10) and provides communications between units (in paralleled systems) and to external entities.

During a utility startup sequence, load/utility grid 680 supplies starting power to turbine 690 by “actively” converting the utility grid power via load or output converter 698 to apply DC to DC bus 414, and then converting the DC to variable voltage, variable frequency 3-phase power in motor/generator converter 696.

As is illustrated in FIG. 9, for stand-alone applications, the start sequence under the control of power controller 400 is the same as the utility start sequence shown in FIG. 8 with the exception that the start power comes from battery 714 under the control of a battery controller. Load 710 is fed from the output terminals of output converter 734 via filter 712.

Referring to FIG. 10, a more detailed schematic illustration of an interface between load/utility grid 772 and turbogenerator 782 using power controller 400 is illustrated. Control logic 746 also provides power to fuel cutoff solenoids 742, fuel control system 744 and igniter 782. Battery controller 762 and battery 764, if used, connect directly to DC bus 414. Fuel control system 744 may be either a control valve or a fuel compressor including a variable speed drive optionally powered from DC bus 414.

In operation, control and start power comes from either energy reservoir controller 762 (for stand alone/battery start applications) or from load/utility grid 772, which is connected via a converter with inrush limiting to slowly charge internal bus capacitor 776.

For utility grid connect start up operations, control logic 746 sequentially drives solid state IGBT switches 768 associated with output converter 734 to boost the utility voltage to provide start power to motor/generator converter 756. Switches 768 are preferably operated at a high (15 kHz) frequency, and modulated in a pulse width modulation (PWM) manner to provide four-quadrant power converter operation. In accordance with the present invention, PWM output converter 756 either sources power from DC bus 414 to utility grid 772 or from utility grid 772 to DC bus 414. A current regulator (not shown) may achieve this control. Optionally, two of the switches 768 serve to create an artificial neutral for stand-alone applications. For stand-alone applications, start power from battery controller/DC power converter (716 of FIG. 9) is applied directly to DC bus 758.

Solid state (IGBT) switches 750 associated with motor/generator converter 754 are also driven from control logic 746, providing a variable voltage, variable frequency 3-phase drive to motor/generator 778 to start turbine engine 780. Control logic 746 receives feedback via current sensors Isens from motor/generator filter 784 as turbine engine 780 is ramped up in speed to complete the start sequence. When turbine engine achieves a self sustaining speed of, for example, approx. 40,000 RPM, motor/generator converter 754 changes its mode of operation to boost the motor/generator output voltage and provide a regulated DC bus voltage.

The voltage, Vsens, at the AC Interface between output contactor 774 and load/utility grid 772 is applied as an input to control logic 746. The temperature of turbine engine 780, Temp Sens, is also applied as an input to control logic 746. Control logic 746 drives IGBT gate drivers 748, release valve 788, fuel cutoff solenoid 742, and fuel supply system components 742 and 744.

Motor/generator filter 784 associated with motor/generator converter 754 includes three inductors to remove the high frequency switching component from motor/generator 778 to increase operating efficiency. Output AC filter 770 associated with output converter 756 includes three or optionally four inductors (not shown) and AC filter capacitors (not shown) to remove the high frequency switching component. Output contactor 774 disengages output converter 756 in the event of a unit fault.

During a start sequence, control logic 746 opens fuel cutoff solenoid 742 and maintains it open until the system is commanded off. Fuel control 744 provides a variable flow with minimum fuel during start and maximum fuel at full load. A variety of fuel controllers, including but not limited to, liquid and gas fuel controllers, may be utilized. Fuel control can be implemented using different configurations, including but not limited to single or dual stage gas compressor 744 accepting fuel pressures as low as approximately ¼ psig. Igniter 786, a spark type device similar to a spark plug for an internal combustion engine, is operated only during the start sequence.

For stand-alone operation, turbine engine 780 is started using external battery controller/DC power converter 762 that boosts voltage from battery 764, and connects directly to the DC bus 24. Output converter 756 is then configured as a constant voltage, constant frequency (for example, approximately 50 or 60 Hz) source One skilled in the art will recognize that the output is not limited to a constant voltage, constant frequency source, but rather may be a variable voltage, variable frequency source. For rapid increases in output demand, external battery controller/DC power converter 762 supplies energy temporarily to DC bus 414 and to the output. The energy is restored after a new operating point is achieved.

For utility grid connect operation, the utility grid power is used for starting as described above. When turbine 780 has reached a desired operating speed, output converter 756 is operated at utility grid frequency, synchronized with utility grid 772, and essentially operates as a current source power converter, requiring utility grid voltage for excitation. If utility grid 772 collapses, the loss of utility grid 772 is sensed, the unit output goes to zero (0) and disconnects. The unit can receive external control signals to control the desired output power, such as to offset the power drawn by a facility, but ensure that the load is not backfed from the system.

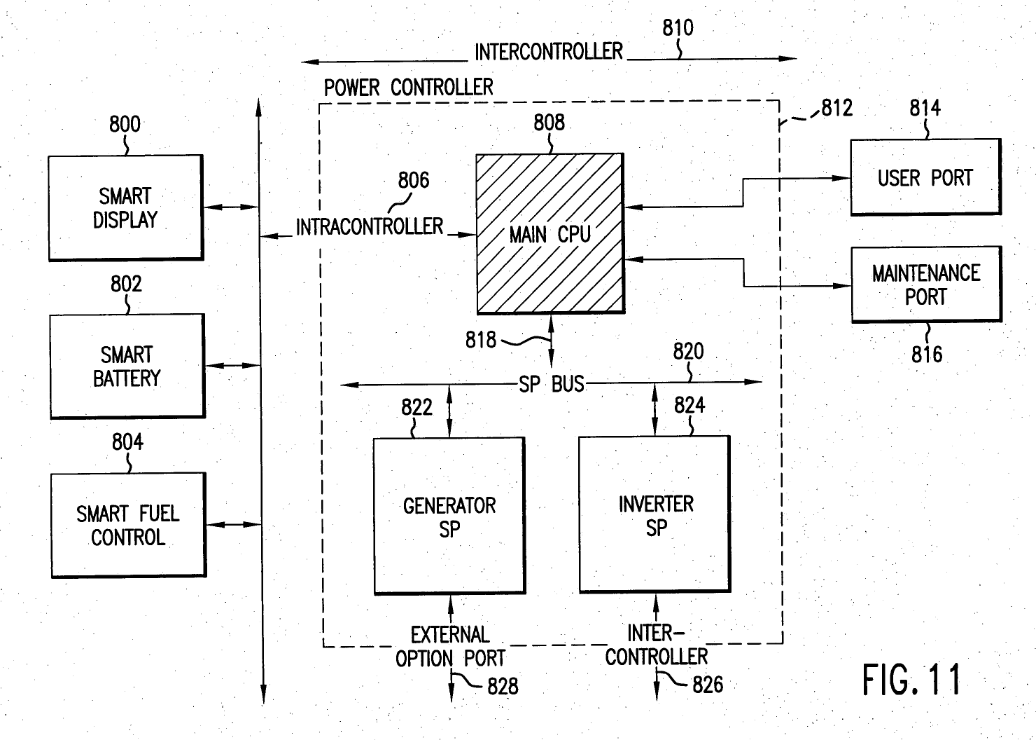

Referring to FIG. 11, power controller logic 812 includes main CPU 808, motor/generator SP 822 and output SP 824. In one embodiment, main CPU software program sequences events which occur inside power controller logic 812 and arbitrates communications to externally connected devices. Main CPU 808 is a MC68332 microprocessor, available from Motorola Semiconductor, Inc. of Phoenix, Ariz. Other suitable commercially available microprocessors may be used as well. The software performs the algorithms that control engine operation, determine power output and detect system faults.

Commanded operating modes are used to determine how power is switched through the major power converters in power controller 812. The software is responsible for turbine engine control and issuing commands to other SP processors enabling them to perform the motor/generator power converter and output/load power converter power switching. The controls also interface with externally connected energy storage devices (not shown) that provide black start and transient capabilities.

Motor/generator SP 822 and output SP 824 are connected to main CPU 808 via serial peripheral interface (SPI) bus 820 to perform motor/generator and output power converter control functions. Motor/generator SP 822 is responsible for any switching that occurs between DC bus (758 of FIG. 10) and motor/generator (778 of FIG. 10). Output SP 824 is responsible for any switching which occurs between DC bus (414 of FIG. 10) and load/utility grid (772 of FIG. 10).

As illustrated in FIG. 7, motor/generator 564 is operated by IGBT module/Generator Converter 598. Converter 598 is controlled by control logic 568 and SP 822 (of FIG. 11) implements a part of that logic. Load 588 is operated by IGBT module/Output Converter 590. Converter 590 is controlled by control logic 580 and SP 824 (of FIG. 11) implements a part of that logic.

Referring back to FIG. 11, local devices, such as a smart display 800, smart battery 802 and smart fuel control 804, are connected to main CPU 808 in via intracontroller bus 806, which may be a RS485 communications link. Smart display 800, smart battery 802 and smart fuel control 804 performs dedicated controller functions, including but not limited to display, energy storage management, and fuel control functions.

Main CPU 808 in power controller logic 812 is coupled to user port 814 for connection to a computer, workstation, modem or other data terminal equipment that allows for data acquisition and/or remote control. User port 814 may be implemented using a RS808 interface or other compatible interface.

Main CPU 808 in power controller logic 812 is also coupled to maintenance port 816 for connection to a computer, workstation, modem or other data terminal equipment which allows for remote development, troubleshooting and field upgrades. Maintenance port 816 may be implemented using a RS808 interface or other compatible interface.

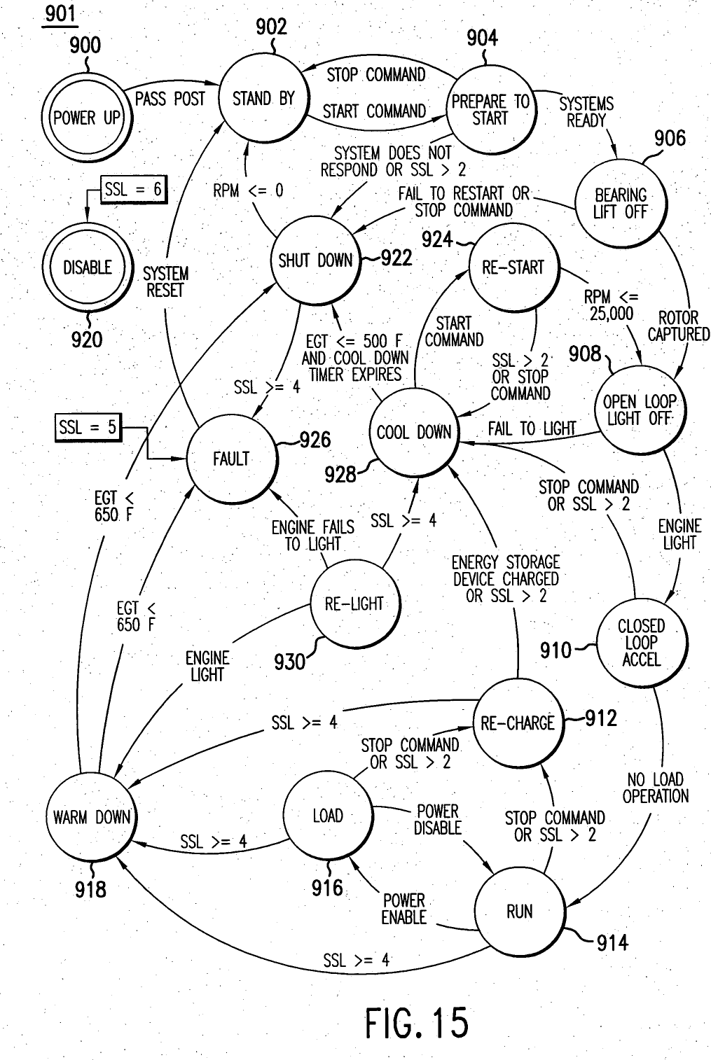

The main CPU processor software communicates data through a TCP/IP stack over intercontroller bus 810, typically an Ethernet 10 Base 2 interface, to gather data and send commands between power controllers (as shown and discussed in detail with respect to FIG. 15). The main CPU processor software provides seamless operation of multiple paralleled units as a single larger generator system. One unit, the master, arbitrates the bus and sends commands to all units.

Intercontroller bus 826, which may be a RS485 communications link, provides high-speed synchronization of power output signals directly between output converter SPs, such as output SP 824. Although the main CPU software is not responsible for communicating on the intercontroller bus 826, it informs output converter SPs, including output SP 824, when main CPU 808 is selected as the master. External option port bus 828, which may be a RS485 communications link, allows external devices, including but not limited to power meter equipment and auto disconnect switches, to be connected to motor/generator SP 822.

In operation, main CPU 808 begins execution with a power on self-test when power is applied to the control board. External devices are detected providing information to determine operating modes the system is configured to handle. Power controller logic 812 waits for a start command by making queries to external devices. Once received, power controller logic 812 sequences up to begin producing power. As a minimum, main CPU 808 sends commands to external smart devices 800, 802 and 804 to assist with bringing power controller logic 812 online.

If selected as the master, the software may also send commands to initiate the sequencing of other power controllers (FIG. 15) connected in parallel. A stop command will shutdown the system taking it offline.

The main CPU 808 software interfaces with several electronic circuits (not shown) on the control board to operate devices that are universal to all power controllers 400. Interface to system I/O begins with initialization of registers within power controller logic 812 to configure internal modes and select external pin control. Once initialized, the software has access to various circuits including discrete inputs/outputs, analog inputs/outputs, and communication ports. These external devices may also have registers within them that require initialization before the device is operational.

Each of the following sub-sections provides a brief overview that defines the peripheral device the software must interface with. The contents of these sub-sections do not define the precise hardware register initialization required.

Still referring to FIG. 11, main CPU 808 is responsible for all communication systems in power controller logic 812. Data transmission between a plurality of power controllers 400 is accomplished through intercontroller bus 810. Main CPU 808 initializes the communications hardware attached to power controller logic 812 for intercontroller bus 810.

Main CPU 808 provides control for external devices, including smart devices 800, 802 and 804, which share information to operate. Data transmission to external devices, including smart display 800, smart battery 802 and smart fuel control 804 devices, is accomplished through intracontroller communications bus 806. Main CPU 808 initializes any communications hardware attached to power controller logic 812 for intracontroller communications bus 806 and implements features defined for the bus master on intracontroller communications bus 806.

Communications between devices such as switchgear and power meters used for master control functions exchange data across external equipment bus 828. Main CPU 808 initializes any communications hardware attached to power controller logic 812 for external equipment bus 828 and implements features defined for the bus master on external equipment bus 804.

Communications with a user computer is accomplished through user interface port 814. Main CPU 808 initializes any communications hardware attached to power controller logic 812 for user interface port 814. In one configuration, at power up, the initial baud rate will be selected to 19200 baud, 8 data bits, 1 stop, and no parity. The user has the ability to adjust and save the communications rate setting via user interface port 814 or optional smart external display 800. The saved communications rate is used the next time power controller logic 812 is powered on. Main CPU 808 communicates with a modem (not shown), such as a Hayes compatible modem, through user interface port 814. Once communications are established, main CPU 808 operates as if were connected to a local computer and operates as a slave on user interface port 814 (e.g., it only responds to commands issued).

Communications to service engineers, maintenance centers, and so forth are accomplished through maintenance interface port 816. Main CPU 808 initializes the communications to any hardware attached to power controller logic 812 for maintenance interface port 816. In one implementation, at power up, the initial baud rate will be selected to 19200 baud, 8 data bits, 1 stop, and no parity. The user has the ability to adjust and save the communications rate setting via user port 814 or optional smart external display 800. The saved communications rate is used the next time power controller logic 812 is powered on. Main CPU 808 communicates with a modem, such as a Hayes compatible modem, through maintenance interface port 816. Once communications are established, main CPU 808 operates as if it were connected to a local computer and operates as a slave on maintenance interface port 816 (e.g., it only responds to commands issued).

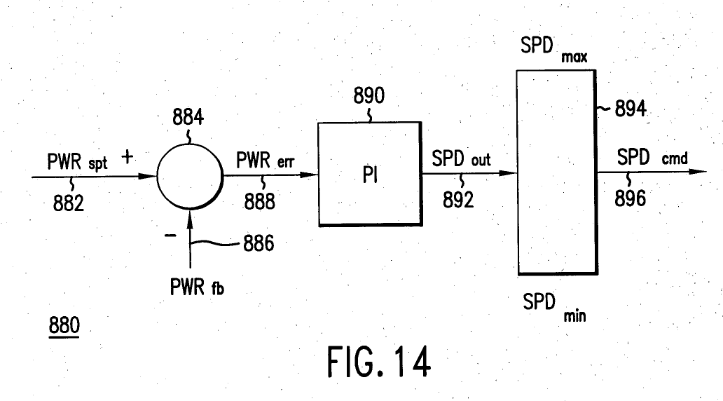

Still referring to FIG. 11, main CPU 808 orchestrates operation for motor/generator, output power converters, and turbine engine controls for power controller logic 812. The In one embodiment, the main CPU 808 does not directly perform motor/generator and output power converter controls. Rather, motor/generator and output SP processors 822 and 824 perform the specific control algorithms based on data communicated from main CPU 808. Engine controls are performed directly by main CPU 808 (see FIG. 14).

Main CPU 808 issues commands via SPI communications bus 820 to motor/generator SP 822 to execute the required motor/generator control functions. Motor/generator SP 822 will operate motor/generator 778, shown in FIG. 10, in either a DC bus mode or a RPM mode as selected by main CPU 808. In the DC bus voltage mode, motor/generator SP 822 uses power from the motor/generator 778 to maintain the DC bus voltage at the set point. In the RPM mode, motor/generator SP 822 uses power from the motor/generator 778 to maintain the engine speed of turbine engine 780 at the set point. Main CPU 808 provides set-point values.

Main CPU 808 issues commands via SPI communications bus 820 to output SP 824 to execute required power converter control functions. Output SP 824 will operate the output converter 734 of FIG. 9, in a DC bus mode, output current mode, or output voltage mode as selected by main CPU 808. In the DC bus voltage mode, output SP 824 regulates the utility power provided by output converter 734 to maintain the voltage of DC bus (414 of FIG. 9) at the set-point.

In the output current mode, output SP 824 uses power from the DC bus 414 to provide commanded current out of the output converter 734 for load/utility grid (772 of FIG. 8). In the output voltage mode, output SP 824 uses power from the DC bus 414 to provide commanded voltage out of the output converter 734 for load/utility grid (710 of FIG. 9). Main CPU 808 provides Set-point values.

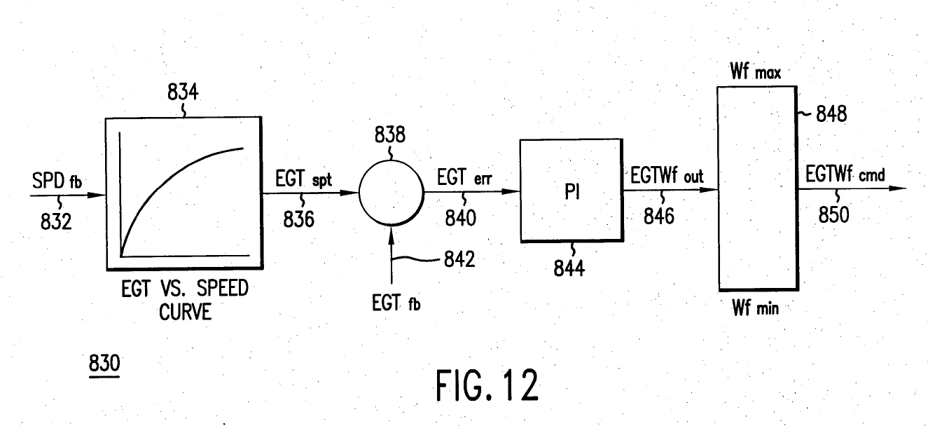

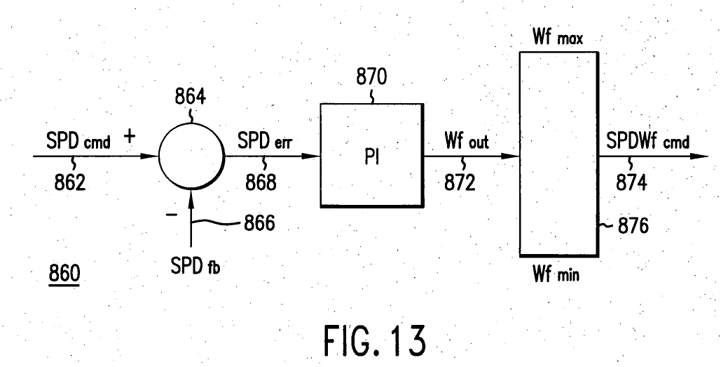

Referring to FIGS. 12-14, control loops 830, 860 and 880 may be used to regulate engine controls of turbine engine (Typical is 780 of FIG. 10). These loops include exhaust gas temperature (EGT) control (FIG. 12), speed control (FIG. 13) and power control (FIG. 14). All three of the control loops 830, 860 and 880 may be used individually and collectively by main CPU 808 to provide the dynamic control and performance required by power controller logic 812. One or more of control loops 830, 860 and 880 may be joined together for different modes of operation.

The open-loop light off control algorithm is a programmed command of the fuel device, such as fuel control system (774 of FIG. 10), used to inject fuel until combustion begins. In one configuration, main CPU 808 takes a snap shot of the engine EGT and begins commanding the fuel device from about 0% to 25% of full command over about 5 seconds. Engine light is declared when the engine EGT rises about 28° C. (50° F.) from the initial snap shot.

Referring to FIG. 12, EGT control loop 830 provides various fuel output commands to regulate the temperature of the turbine engine 148. Engine speed signal 832 is used to determine the maximum EGT set-point temperature 836 in accordance with predetermined set-point temperature values illustrated in EGT vs. Speed Curve 834. EGT set-point temperature 836 is compared by comparator 838 against feedback EGT signal 842 to determine EGT error signal 840 that is applied to a proportional-integral (PI) algorithm 844 for determining the fuel command 846 required to regulate EGT to the set-point. Maximum/minimum fuel limits 848 are used to limit EGT control algorithm fuel command output 846 to protect from integrator windup. Resultant EGT fuel output signal 850 is the regulated EGT signal fuel flow command. In one operating embodiment, EGT control mode loop 830 operates at about a 100 ms rate.

Referring to FIG. 13, speed control mode loop 860 provides various fuel output commands to regulate the rotating speed of the turbine engine 148. Feedback speed signal 866 is read and compared by comparator 864 against set-point speed signal 862 to determine error signal 868, which is then applied to PI algorithm 870 to determine the fuel command required to regulate turbine engine speed at the set-point. EGT control (FIG. 12) and maximum/minimum fuel limits are used in conjunction with the speed control algorithm 860 to protect output signal 872 from surge and flame out conditions. Resultant output signal 874 is regulated turbine speed fuel flow command. In one implementation, speed control mode loop 860 operates at about a 20 ms rate.

Referring to FIG. 14, power control loop 880 regulates the power producing potential of turbogenerator 782. Feedback power signal 886 is read and compared by comparator 884 against set-point power signal 882 to determine power error signal 888, which is then applied to PI algorithm 890 to determine the speed command required to regulate output power at the set-point. Maximum/minimum speed limits are used to limit the power control algorithm speed command output to protect output signal 892 from running into over speed and under speed conditions. Resultant output signal 896 is regulated power signal turbine speed command. In one implementation, the maximum operating speed of the turbine engine is generally 96,000 RPM and the minimum operating speed of the turbine is generally 45,000 RPM. The In one embodiment, the loop operates at about a 500 ms rate.

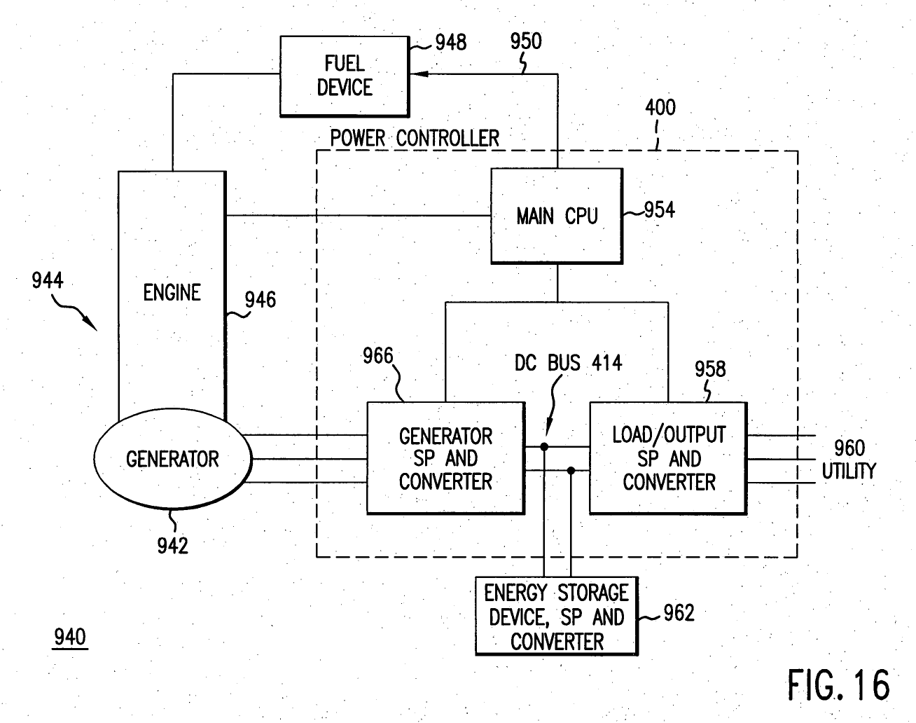

Referring to FIG. 16, the energy storage device in energy storage SP and power converter 962, such as a battery, flywheel or super capacitor (764 of FIG. 10), may be a start only device. In the DC bus voltage control mode, the start only storage device provides energy to regulate voltage on DC bus 414 to the bus voltage set-point command. Main CPU 808 commands the bus voltage on DC bus 414 to control at different voltage set-point values depending on the configuration of power controller 400. In the state of charge (SOC) control mode, the start only device system provides a recharging power demand when requested. Available recharging power is generally equivalent to maximum engine power less power being supplied to the output load and system parasitic loads. Main CPU 808 transmits a recharging power level that is the minimum of the original power demand and available recharging power.

The transient energy storage provides the DC bus voltage control as described below as well as the state of charge (SOC) control mode described for the start only energy storage. The transient energy storage contains a larger energy storage device than the start only energy storage.

In the DC Bus Voltage Control mode, DC bus 414 supplies power for logic power, external components and system power output. In one embodiment, TABLE 1 defines the set-point the bus voltage is to be controlled at based on the output power configuration of power controller 400:

TABLE 1

| POWER OUTPUT | SET-POINT |
|---|---|
| 480/400 VAC Output | 800 Vdc |
| 240/208 VAC Output | 400 VDC |

In the various operating modes, power controller 400 will have different control algorithms responsible for managing the DC bus voltage level. Any of the battery options in energy storage SP and power converter 470 as well as SPs 456 and 458 have modes that control power flow to regulate the voltage level of DC bus 414. Under any operating circumstances, only one device is commanded to a mode that regulates DC bus 414. Multiple algorithms would require sharing logic that would inevitably make system response slower and software more difficult to comprehend. Referring now also to FIG. 15, state diagram 901 show various operating states of power controller 400 according to one embodiment. Sequencing the system through the entire operating procedure requires power controller 400 to transition through the operating states defined in TABLE 2.

Table 2

STATE SYSTEM DESCRIPTION

922 Power Up:

Performs activities of initializing and testing the system. Upon passing Power On Self Test (POST),move to standby state 902.

902 Stand By:

Closer power to bus and continues system monitoring while waiting for a start command. Upon receipt of Start Command, move to Prepare to Start state 904.

904 Prepare to Start:

Initializes any external devices preparing for the start procedure. returns to Stand By state 902 if Stop Command received. Moves to Shut Down state 922 if systems do not respond or if a fault is detected with a system severity level (SSL) greater than 2. Upon systems ready, move to Bearing Lift Off state 906.

906 Bearing Lift Off:

Configures the system and commands turbine engine 780 to be rotated to a predetermined RPM, such as 25,000 RPM. Moves to Shut Down state 922 upon failure of turbine engine 780 of FIG. 8) to rotate, or receipt of a Stop Command. Upon capture of rotor in motor/generator (Typical is 788 of FIG. 10), moves to Open Loop Light Off state 908.

908 Open Loop Light Off:

Turns on ignition system and commands fuel open loop to light turbine engine (Typical is 780 of FIG. 10). Moves to Cool Down state 928 upon failure to light. Upon turbine engine (Typical is 780 of FIG. 10) light off, moves to Closed Loop Acceleration state 902.

910 Closed Loop Acceleration:

Continues motoring turbine engine (Typical is 780 of FIG. 10) using closed loop fuel control until the turbogenerator system 50 reaches a predetermined RPM, designated as the No Load state. Moves to Cool Down state 928 upon receipt of Stop Command or if a fault occurs with a SSL greater than 2. Upon reaching No Load state, moves to Run state 914.

914 Run Turbine:

Engine (Typical is 780 of FIG. 10) operates in a no load, self-sustaining state producing power to operate the power controller 400. Moves to Warm Down state 918 if SSL is greater than or equal to 4. Moves to Re-Charge state 912 if Stop Command is received or if a fault occurs with a SSL less than 2. Upon receipt of Power Enable command, moves to Load state 916.

916 Load Converter:

Output contactor 210 is closed and turbogenerator system 50 is producing power applied to load (Typical is 772 of FIG. 10). Moves to Warm Down state 918 if a fault occurs with a SSL greater or equal to 4. Moves to Run state 914 if Power Disable command is received. Moves to Re-Charge state 912 if Stop Command is received or if a fault occurs with a SSL greater than 2.

912 Re-Charge System:

Operates off of fuel only and produces power for recharging energy storage device if installed, such as battery (Typical is 764 of FIG. 10) shown in FIG. 8. Moves to Cool Down state 900 when energy storage device is fully charged or if a fault occurs with a SSL greater than 2. Moves to Warm Down state if a fault occurs with a SSL greater than or equal to 4.

928 Cool Down:

Motor/Generator (Typical is 778 of FIG. 10) is motoring turbine engine (Typical is 780 of FIG. 10) to reduce EGT before moving to Shut Down state 922. Moves to Re-Start state 924 if Start Command received. Upon expiration of Cool Down Timer, moves to Shut Down state 922 when EGT is less than or equal to 500° F.

924 Re-Start:

Reduces speed of turbine engine (Typical is 780 of FIG. 10) to begin open loop light off when a Start Command is received in the Cool Down state 928. Moves to Cool Down state 928 if Stop Command is received or if a fault occurs with a SSL greater than 2. Upon reaching RPM less than or equal to 25,000 RPM, moves to Open Loop Light Off state 908.

930 Re-Light:

Performs a re-light of turbine engine (Typical is 780 of FIG. 10) during transition from the Warm Down state 918 to Cool Down state 928. Allows continued engine cooling when motoring is no longer possible. Moves to Cool Down state 928 if a fault occurs with a SSL greater than or equal to 4. Moves to Fault state 926 if turbine engine (Typical is 780 of FIG. 10) fails to light. Upon light off of turbine engine (Typical is 780 of FIG. 10), moves to Closed Loop Acceleration state 910.

918 Warm Down:

Sustains operation of turbine engine (Typical is 780 of FIG. 10) with fuel at a predetermined RPM, such as 50,000 RPM, to cool turbine engine (Typical is 780 of FIG. 10) when motoring of turbine engine (Typical is 780 of FIG. 10) by motor/generator (Typical is 778 of FIG. 10) is not possible. Moves to Fault state 926 if EGT is not less than 650° F. within a predetermined time. Upon achieving an EGT less than 650° F., moves to Shut Down state 922.

922 Shutdown:

Reconfigures turbogenerator system 50 after a cooldown in Cool Down state 928 or Warm Down state 918 to enter the Stand By state 902. Moves to Fault state 926 if a fault occurs with a SSL greater than or equal to 4. Moves to Stand By state 902 when RPM is less than or equal to zero.

926 Fault:

Turns off all outputs when a fault occurs with a SSL equal to 5 indicating that the presence of a fault which disables power conversion exists. Logic power is still available for interrogating system faults. Moves to Stand By state 902 upon receipt of System Reset.

920 Disable:

Fault has occurred where processing may no longer be possible. All system operation is disabled when a SSL=6 fault occurs.

Main CPU 808 begins execution in Power Up state 900 after power is applied. Transition to Stand By state 902 is performed upon successfully completing the tasks of Power Up state 900. Initiating a start cycle transitions the system to Prepare to Start state 904 where all system components are initialized for an engine start of turbine engine (Typical is 780 of FIG. 10). The turbine engine (Typical is 780 of FIG. 10) then sequences through start states including Bearing Lift Off state 906, Open Loop Light Off state 908 and Closed Loop Acceleration state 910 and moves on to the “run/load” states, Run state 914 and Load state 916.

To shutdown the system, a stop command that sends the system into either Warm Down state 918 or Cool Down state 928 is initiated. Systems that have a battery may enter Re-Charge state 912 prior to entering Warm Down state 918 or Cool Down state 928. When the system has finally completed the “warm down” or “cool down” process in Warm Down state 918 or Cool Down state 928, a transition through Shut Down state 922 will be made before the system re-enters Stand By state 902 awaiting the next start cycle. During any state, detection of a fault with a system severity level (SSL) equal to 5, indicating that the system should not be operated, will transition the system state to Fault state 912. Detection of faults with an SSL equal to 6 indicates a processor failure has occurred and will transition the system to Disable state 920.

In order to accommodate each mode of operation, the state diagram is multidimensional to provide a unique state for each operating mode. For example, in Prepare to Start state 904, control requirements will vary depending on the selected operating mode. Therefore, the presence of separate stand-alone Prepare to Start state 904, stand-alone transient Prepare to Start state 904, utility grid connect Prepare to Start state 904 and utility grid connect transient Prepare to Start state 904 may be required.

Each combination is known as a system configuration (SYSCON) sequence. Main CPU 808 identifies each of the different system configuration sequences in a 16-bit word known as a SYSCON word, which is a bit-wise construction of an operating mode and system state number. In one configuration, the system state number is packed in bits 0 through 11. The operating mode number is packed in bits 12 through 15. This packing method provides the system with the capability of sequence through 4096 different system states in 16 different operating modes.

In one embodiment, separate Power Up states 900, Re-Light states 930, Warm Down states 918, Fault states 926 and Disable states 920 may not be required for each mode of operation. The contents of these states are mode independent.

Power Up state 900: Operation of the system begins in Power Up state 900 once application of power activates main CPU 232. Once power is applied to power controller 400, all the hardware components will be automatically reset by hardware circuitry. Main CPU 808 is responsible for ensuring the hardware is functioning correctly and configuring the components for operation. Main CPU 808 also initializes its own internal data structures and begins execution by starting the Real-Time Operating System (RTOS). Successful completion of these tasks directs transition of the software to Stand By state 902. Main In one embodiment, main CPU 808 performs these procedures in the following order:

1. Initialize main CPU 808

2. Perform RAM Test

3. Perform FLASH Checksum

4. Start RTOS

5. Run Remaining POST

6. Initialize SPI Communications

7. Verify Motor/Generator SP Checksum

8. Verify Output SP Checksum

9. Initialize IntraController Communications

10. Resolve External Device Addresses

11. Look at Input Line Voltage

12. Determine Mode

13. Initialize Maintenance Port

14. Initialize User Port

15. Initialize External Option Port

16. Initialize InterController

17. Chose Master/Co-Master

18. Resolve Addressing

19. Transition to Stand By State (depends on operating mode)

Stand By state 902: Main CPU 808 continues to perform normal system monitoring in Stand By state 902 while it waits for a start command signal. Main CPU 808 commands either energy storage SP and power converter 962 or load/utility grid 960 to provide continuous power supply. In operation, main CPU 808 will often be left powered on waiting to be start started or for troubleshooting purposes. While main CPU 808 is powered up, the software continues to monitor the system and perform diagnostics in case any failures should occur. All communications will continue to operate providing interface to external sources. A start command will transition the system to the Prepared to Start state 904.

Prepared to Start state 904: Main CPU 808 prepares the control system components for turbine engine (Typical is 780 of FIG. 10) start process. Many external devices may require additional time for hardware initialization before the actual start procedure can commence. The Prepared to Start state 904 provides those devices the necessary time to perform initialization and send acknowledgment to main CPU 808 that the start process can begin. Once also systems are ready to go, the software will transition to the Bearing Lift Off state 906.

Bearing Lift Off state 906: Main CPU 808 commands motor/generator SP and power converter 456 to motor the turbine engine (Typical is 780 of FIG. 10) from typically about 0 to 25,000 RPM to accomplish the bearing lift off procedure. A check is performed to ensure the shaft of turbine engine (Typical is 780 of FIG. 10) is rotating before transition to the next state occurs.

Open Loop Light Off state 908: Once the motor/generator (Typical is 778 of FIG. 10) reaches its liftoff speed, the software commences and ensures combustion is occurring in the turbine engine (Typical is 780 of FIG. 10). In a typical configuration, main CPU 808 commands motor/generator SP and power converter 966 to motor the turbine engine (Typical is 780 of FIG. 10) to a dwell speed of about 25,000 RPM. Execution of Open Loop Light Off state 908 starts combustion. Main CPU 808 then verifies that turbine engine (Typical is 780 of FIG. 10) has not met the “fail to light” criteria before transition to the Closed Loop Acceleration state 910.

Closed Loop Acceleration state 910: Main CPU 808 sequences turbine engine (Typical is 780 of FIG. 10) through a combustion heating process to bring turbine engine (Typical is 780 of FIG. 10) to a self-sustaining operating point. In one configuration, commands are provided to motor/generator SP and power converter 966 commanding an increase in turbine engine speed to about 45,000 RPM at a rate of about 4000 RPM/sec. Fuel controls of fuel supply system 948 are executed to provide combustion and engine heating. When turbine engine (Typical is 780 of FIG. 10) reaches “no load” (requires no electrical power to motor), the software transitions to Run state 914.

Run state 914: Main CPU 808 continues operation of control algorithms to operate turbine engine (Typical is 780 of FIG. 10) at no load. Power may be produced from turbine engine (Typical is 780 of FIG. 10) for operating control electronics and recharging any energy storage device, such as battery (Typical is 764 of FIG. 8), in energy storage SP and power converter 962 for starting. No power is output from output SP and power converter 958. A power enable signal transitions the software into Load state 916. A stop command transitions the system to begin shutdown procedures (may vary depending on operating mode).

Load state 916: Main CPU 808 continues operation of control algorithms to operate turbogenerator 944 at the desired load. Load commands are issued through the communications ports, display or system loads. A stop command transitions main CPU 808 to begin shutdown procedures (may vary depending on operating mode). A power disable signal can transition main CPU 808 back to Run state 914.

Re-charge state 912: Systems that have an energy storage option may be required to charge the energy storage device, such as battery (Typical is 764 of FIG. 8), in energy storage SP and power converter 962 to maximum capacity before entering Warm Down state 918 or Cool Down state 928. During Recharge state 912, main CPU 808 continues operation of the turbogenerator 58 producing power for battery charging and power controller 400. No output power is provided. When energy storage device 764 has been charged, the system transitions to either Cool Down state 928 or Warm Down state 918, depending on system fault conditions.

Cool Down state 928: Cool Down state 928 provides the ability to cool the turbine engine (Typical is 780 of FIG. 10) after operation and a means of purging fuel from the combustor. After normal operation, software sequences the system into Cool Down state 928. In one configuration, turbine engine (Typical is 780 of FIG. 10) is motored to a cool down speed of about 45,000 RPM. Airflow continues to move through turbine engine (Typical is 780 of FIG. 10) preventing hot air from migrating to mechanical components in the cold section. This motoring process continues until the turbine engine EGT falls below a cool down temperature of about 193° C. (380° F.). Cool Down state 928 may be entered at much lower than the final cool down temperature when turbine engine (Typical is 780 of FIG. 10) fails to light. The engine's combustor of turbine engine (Typical is 780 of FIG. 10) requires purging of excess fuel which may remain. The In one embodiment, the software operates the cool down cycle for a minimum purge time of 60 seconds. This purge time ensures remaining fuel is evacuated from the combustor. Completion of this process transitions the system into Shut Down state 922. For user convenience, the system does not require a completion of the entire Cool Down state 928 before being able to attempt a restart. Issuing a start command transitions the system into Restart state 924.

Restart state 924: In Restart state 924, turbine engine (Typical is 780 of FIG. 10) is configured from Cool Down state 928 before turbine engine (Typical is 780 of FIG. 10) can be restarted. In one configuration, the software lowers the speed of turbine engine (Typical is 780 of FIG. 10) to about 25,000 RPM at a rate of 4,000 RPM/sec. Once the turbine engine speed has reached this level, the software transitions the system into Open Loop Light Off state 908 to perform the actual engine start.

Shutdown state 922: During Shut Down state 922, the turbine engine and motor/generator rotor shaft is brought to rest and system outputs are configured for idle operation. In one configuration, the software commands the rotor shaft to rest by lowering the turbine engine speed at a rate of 2,000 RPM/sec or no load condition, whichever is faster. Once the speed reaches about 14,000 RPM, the motor/generator SP and power converter 966 is commanded to reduce the shaft speed to about 0 RPM in less than 1 second.

Re-light state 930: When a system fault occurs, where no power is provided from the load/utility grid 960 or energy storage SP and power converter 962, the software re-ignites combustion to perform Warm Down state 918. The motor/generator SP and power converter 966 is configured to regulate voltage (power) for the internal DC bus. Fuel is added in accordance with the open loop light off fuel control algorithm in Open Loop Light Off state 908 to ensure combustion occurs. Detection of engine light will transition the system to Warm Down state 918.

Warm Down state 918: Fuel is provided, when no electric power is available to motor turbine engine (Typical is 780 of FIG. 10) at a no load condition, to lower the operating temperature in Warm Down state 918. In one configuration, engine speed is operated at about 50,000 RPM by supplying fuel through the speed control algorithm described below with regard to FIG. 13. EGT temperatures of turbine engine (Typical is 780 of FIG. 10) less than about 343° C. (650° F.) causes the system to transition to Shut Down state 922.

Fault state 912: The system disables all outputs placing the system in a safe configuration when faults that prohibit safe operation of the turbine system are present. Operation of system monitoring and communications will continue if the energy is available.

Disable State 920: The system disables all outputs placing the system in a safe configuration when faults that prohibit safe operation of the turbine system are present. System monitoring and communications will most likely not continue.

Modes of Operation: The turbine works in two major modes—utility grid-connect and stand-alone. In the utility grid-connect mode, the electric power distribution system i.e., the utility grid of load/utility grid 960, supplies a reference voltage and phase, and turbogenerator 944 supplies power in synchronism with the utility grid. In the stand-alone mode, turbogenerator 944 supplies its own reference voltage and phase, and supplies power directly to the load. The power controller 400 switches automatically between the modes.

Within the two major modes of operation are sub-modes. These modes include stand-alone black start, stand-alone transient, utility grid connect and utility grid connect transient. The criterion(ria) for selecting an operating mode is based on numerous factors, including but not limited to, the presence of voltage on the output terminals, the black start battery option, and the transient battery option.

Referring to FIG. 16, motor/generator SP and power converter 966 and output SP and power converter 958 provide an interface for energy source 962 and utility/load 960, respectively, to DC bus 964. For illustrative purposes, energy source 962 is turbogenerator (Typical is 782 of FIG. 8) including turbine engine (Typical is 780 of FIG. 10) and motor/generator (Typical is 778 of FIG. 10). Fuel control (744 of FIG. 8) provides fuel to turbine engine (Typical is 780 of FIG. 10).

Motor/generator power converter 966, which may include motor/generator SP 822 and motor/generator converter 598 of FIG. 7, and output power converter 958, which may include output SP 824 and output converter 590 of FIG. 7, operate as customized bi-directional, switching power converters under the control of main CPU 808. In particular, main CPU 808 reconfigures the motor/generator power converter 966 and output power converter 958 into different configurations to provide for the various modes of operation. These modes include stand-alone black start, stand-alone transient, utility grid connect and utility grid connect transient as discussed in detail below.

Power controller 952 controls the way in which motor/generator 942 and load/utility grid 960 sinks or sources power, and DC bus 964 is regulated, at any time. In this way, energy source 962, which may include energy source, SP, and converter and load/utility grid 960 can be used to supply, store and/or use power in an efficient manner. Main CPU 808 provides command signals via line 953 to turbine engine 946 to determine the speed of turbogenerator 944. The speed of turbogenerator 944 is maintained through motor/generator 942 control. The main CPU 954 also provides command signals via fuel control line 950 to fuel control 948 to maintain the EGT of turbine engine 946 at its maximum efficiency point. Motor/generator SP 822, operating motor/generator converter 730, is responsible for maintaining the speed of turbogenerator 726, by putting current into or pulling current out of motor/generator 720.

Stand-Alone Black Start

Referring to FIG. 16, in the stand-alone black start mode, the energy source device associated with energy source 962, such as a battery, flywheel, or ultra capacitor, is provided for starting purposes while energy source 944 which may be a turbogenerator supplies transient and steady state energy. Referring to TABLE 3, controls for one embodiment of a stand-alone black start mode are shown.

TABLE 3

| | ENGINE | MOTOR | CONVERTER | ENERGY STORAGE |
|---|---|---|---|---|
| SYSTEM STATE | CONTROLS | CONTROLS | CONTROLS | CONTROLS |
| Power Up | — | — | — | — |
| Stand By | — | — | — | DC Bus |
| Prepare to Start | — | — | — | DC Bus |
| Bearing Lift Off | — | RPM | | -DC Bus |
| Open Loop Light Off | Open Loop Light | RPM | | -DC Bus |
| Closed Loop Accel | EGT | RPM | — | DC Bus |
| Run | Speed | DC Bus | — | SOC |
| Load | Speed | DC Bus | Voltage | SOC |
| Recharge | Speed | DC Bus | — | SOC |
| Cool Down | — | RPM | — | DC Bus |
| Restart | — | RPM | — | DC Bus |
| Shutdown | — | RPM | — | DC Bus: |
| Re-light | Speed | DC Bus | — | — |
| Warm Down | Speed | DC Bus | — | — |
| Fault | — | — | — | — |
| Disable | — | — | — | — |

Stand-Alone Transient

In the stand-alone transient mode, energy source 962, including energy source SP and converter as well as energy storage, are provided for the purpose of starting and assisting the energy source 962, in this example a turbogenerator 944, to supply maximum rated output power during transient conditions. Energy source 962 is attached to DC bus 964 during operation, supplying energy in the form of current to maintain the voltage on DC bus 964. Power converter 958, including output SP and output converter, provides a constant voltage source when producing output power. As a result, load/utility grid 960 is always supplied the proper AC voltage value that it requires. Referring to TABLE 4, controls for one embodiment of a stand-alone transient mode are shown.

TABLE 4

| SYSTEM | ENGINE | MOTOR | CONVERTER | ENERGY SOURCE |
|---|---|---|---|---|
| STATE | CONTROLS | CONTROLS | CONTROLS | CONTROLS |
| Power Up | — | — | — | — |
| Stand By | — | — | — | DC Bus |
| Prepare to Start | — | — | — | DC Bus |
| Bearing Lift Off | — | RPM | — | DC Bus |
| Open Loop Light Off | Open Loop Light | RPM | — | DC Bus |
| Closed Loop Accel | EGT | RPM | — | DC Bus |
| Run | Power & EGT | RPM | — | DC Bus |
| Load | Power & EGT | RPM | Voltage | DC Bus |
| Recharge | Power & EGT | RPM | — | DC Bus |
| Cool Down | — | RPM | — | DC Bus |
| Restart | — | RPM | — | DC Bus |
| Shutdown | — | RPM | — | DC Bus |
| Re-light | Speed | DC Bus | — | — |
| Warm Down | Speed | DC Bus | — | — |
| Fault | — | — | — | — |

Utility Grid Connect

Referring to FIG. 16, in the utility grid connect mode, the energy source 962, in this example turbogenerator 944, is connected to the load/utility grid 960 providing load leveling and management where transients are handled by the load/utility grid 960. The system operates as a current source, pumping current into load/utility grid 960. Referring to TABLE 5, controls for one embodiment of a utility grid connect mode are shown.

TABLE 5

| SYSTEM | ENGINE | MOTOR | CONVERTER | ENERGY SOURCE |
|---|---|---|---|---|
| STATE | CONTROLS | CONTROLS | CONTROLS | CONTROLS |
| Power Up | — | — | — | N/A |
| Stand By | — | — | — | N/A |
| Prepare to Start | — | — | DC Bus | N/A |
| Bearing Lift Off | — | RPM | DC Bus | N/A |
| Open Loop Light Off | Open Loop Light | RPM | DC Bus | N/A |
| Closed Loop Aced | EGT | RPM | DC Bus | N/A |
| Run | Power & EGT | RPM | DC Bus | N/A |
| Load | Power & EGT | RPM | DC Bus | N/A |
| Recharge | N/A | N/A | N/A | N/A |
| Cool Down | — | RPM | DC Bus | N/A |
| Restart | — | RPM | DC Bus | N/A |
| Shutdown | — | RPM | DC Bus | N/A |
| Re-light | Speed | DC Bus | — | N/A |
| Warm Down | Speed | DC Bus | — | N/A |
| Fault | — | — | — | N/A |
| Disable | — | — | — | N/A |

Utility Grid Connect Transient: In the utility grid connect transient mode, energy source 944 (in this example a turbogenerator) is coupled via generator and output converters to the load/utility grid 960 providing load leveling and management. Energy source 962 is coupled to the DC bus and assists turbogenerator 944 in handling transients. The system operates as a current source, pumping current into load/utility grid 960. Referring to TABLE 6, controls for one embodiment of a utility grid connect transient mode are shown.

TABLE 6

| SYSTEM | ENGINE | MOTOR | CONVERTER | ENERGY SOURCE |
|---|---|---|---|---|
| STATE | CONTROLS | CONTROLS | CONTROLS | CONTROLS |
| Power Up | — | — | — | — |
| Stand By | — | — | — | DC Bus |
| Prepare to Start | — | — | — | DC Bus |
| Bearing Lift Off | — | RPM | — | DC Bus |
| Open Loop Light Off | Open Loop Light | RPM | — | DC Bus |
| Closed Loop Accel | EGT | RPM | — | DC Bus |
| Run | Power & EGT | RPM | — | DC Bus |
| Load | Power & EGT | RPM | Current | DC Bus |
| Recharge | Power & EGT | RPM | — | DC Bus |
| Cool Down | — | RPM | — | DC Bus |
| Restart | — | RPM | — | DC Bus |
| Shutdown | — | RPM | — | DC Bus |
| Re-light | Speed | DC Bus | — | — |
| Warm Down | Speed | DC Bus | — | — |
| Fault | — | — | — | — |
| Disable | — | — | — | — |

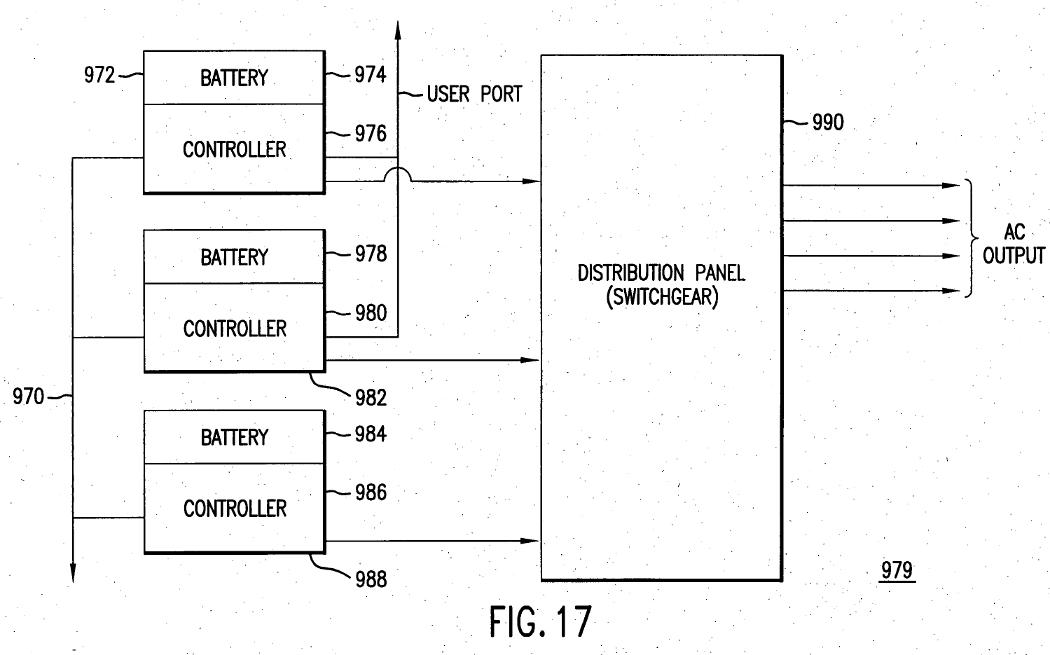

Multi-pack Operation:The power controller can operate in a single or multi-pack configuration. In particular, power controller 952, in addition to being a controller for a single turbogenerator, is capable of sequencing multiple turbogenerator systems as well. Referring now to FIG. 17, for illustrative purposes, multi-pack system 979 including three power controllers 976, 980 and 986 is shown. The ability to control multiple power controllers 976, 980 and 986 is made possible through digital communications interface and control logic contained in each controller's main CPU (not shown).

Two communications busses 970 and 981 are used to create the intercontroller digital communications interface for multi-pack operation. One bus 981 is used for slower data exchange while the other bus 970 generates synchronization packets at a faster rate. In a typical implementation, for example, an IEEE-502.3 bus links each of the controllers 976, 980 and 986 together for slower communications including data acquisition, start, stop, power demand and mode selection functionality. An RS485 bus links each of the systems together providing synchronization of the output power waveforms.

The number of power controllers that can be connected together is not limited to three, but rather any number of controllers can be connected together in a multi-pack configuration. Each power controller 976, 980 and 986 includes its own energy storage device 974, 978 and 984, respectively, such as a battery. In accordance with another embodiment, power controllers 976, 980 and 986 can all be connected to the same single energy storage device (not shown), typically a very large energy storage device that would be rated too big for an individual turbine. Distribution panel 990, typically comprised of circuit breakers, provides for distribution of energy.

Multi-pack control logic determines at power up that one controller is the master and the other controllers become slave devices. The master is in charge of handling all user-input commands, initiating all inter-system communications transactions, and dispatching units. While all controllers 976, 980 and 986 contain the functionality to be a master, to alleviate control and bus contention, one controller is designated as the master.

At power up, the individual controllers 976, 980 and 986 determine what external input devices they have connected. When a controller contains a minimum number of input devices it sends a transmission on intercontroller bus 970 claiming to be master. All controllers 976, 980 and 986 claiming to be a master begin resolving who should be master. Once a master is chosen, an address resolution protocol is executed to assign addresses to each slave system. After choosing the master and assigning slave addresses, multi-pack system 979 can begin operating.

A co-master is also selected during the master and address resolution cycle. The job of the co-master is to act like a slave during normal operations. The co-master should receive a constant transmission packet from the master indicating that the master is still operating correctly. When this packet is not received within a safe time period, 20 ms for example, the co-master may immediately become the master and take over master control responsibilities.

Logic in the master configures all slave turbogenerator systems. Slaves are selected to be either utility grid-connect (current source) or standalone (voltage source). A master controller, when selected, will communicate with its output converter logic (output SP) that this system is a master. The output SP is then responsible for transmitting packets over the intercontroller bus 970, synchronizing the output waveforms with all slave systems. Transmitted packets will include at least the angle of the output waveform and error-checking information with transmission expected every quarter cycle to one cycle.

Master control logic will dispatch units based on one of three modes of operation: (1) peak shaving, (2) load following, or (3) base load. Peak shaving measures the total power consumption in a building or application using a power meter, and the multi-pack system 979 reduces the utility consumption of a fixed load, thereby reducing the utility rate schedule and increasing the overall economic return of the system. Load following is a subset of peak shaving where a power meter measures the total power consumption in a building or application and the multi-pack system 979 reduces the utility consumption to zero load. In base load, the multi-pack system 979 provides a fixed load and the utility supplements the load in a building or application. Each of these control modes require different control strategies to optimize the total operating efficiency.

A minimum number of input devices are typically desired for a system 979 to claim it is a master during the master resolution process. Input devices that are looked for include a display panel, an active RS232 connection and a power meter connected to the option port. Multi-pack system 510 typically requires a display panel or RS232 connection for receiving user-input commands and power meter for load following or peak shaving.

In one embodiment, the master control logic dispatches controllers based on operating time. This would involve turning off controllers that have been operating for long periods of time and turning on controllers with less operating time, thereby reducing wear on specific systems.

Utility Grid Analysis and Transient Ride Through

Referring to FIGS. 16-18, a transient handling system 1000 for power controller 1044 is illustrated. Transient handling system 1000 allows power controller 1044 to ride through transients which are associated with switching of correction capacitors (not shown) on load/utility grid 1050 which causes voltage spikes followed by ringing. Transient handling system 1000 also allows ride through of other faults, including but not limited to, short circuit faults on load/utility grid 1050, which cleared successfully, cause voltage sags. Transient handling system 1000 is particularly effective towards handling transients associated with digital controllers, which generally have a slower current response rate due to A/D conversion sampling. During a transient, a large change in the current can occur in between A/D conversions. The high voltage impulse caused by transients typically causes an over current in digital power controllers.

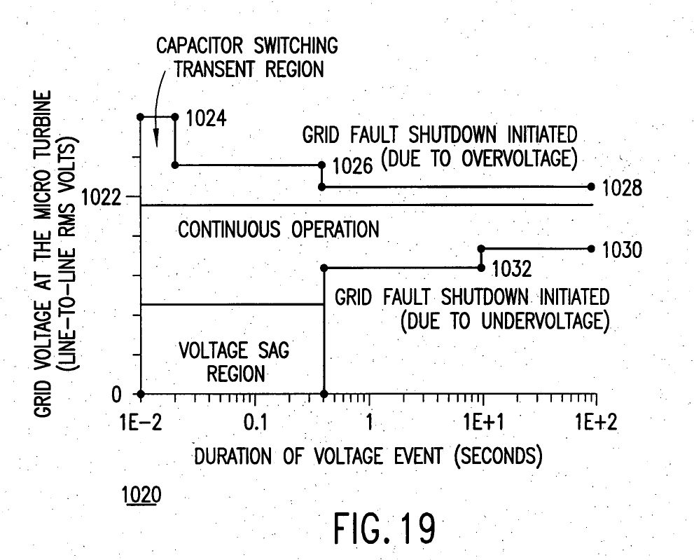

As is illustrated in FIG. 19, a graph 1020 showing transients typically present on load/utility grid 1050 is shown. The duration of a voltage transient, measured in seconds, is shown on the x-axis and its magnitude, and measured in volts, is shown on the y-axis. A capacitor switching transient, such as shown at 592, which is relatively high in magnitude (up to about 200%) and short in duration (somewhere between 1 and 20 milliseconds) could be problematic to operation of a power controller.

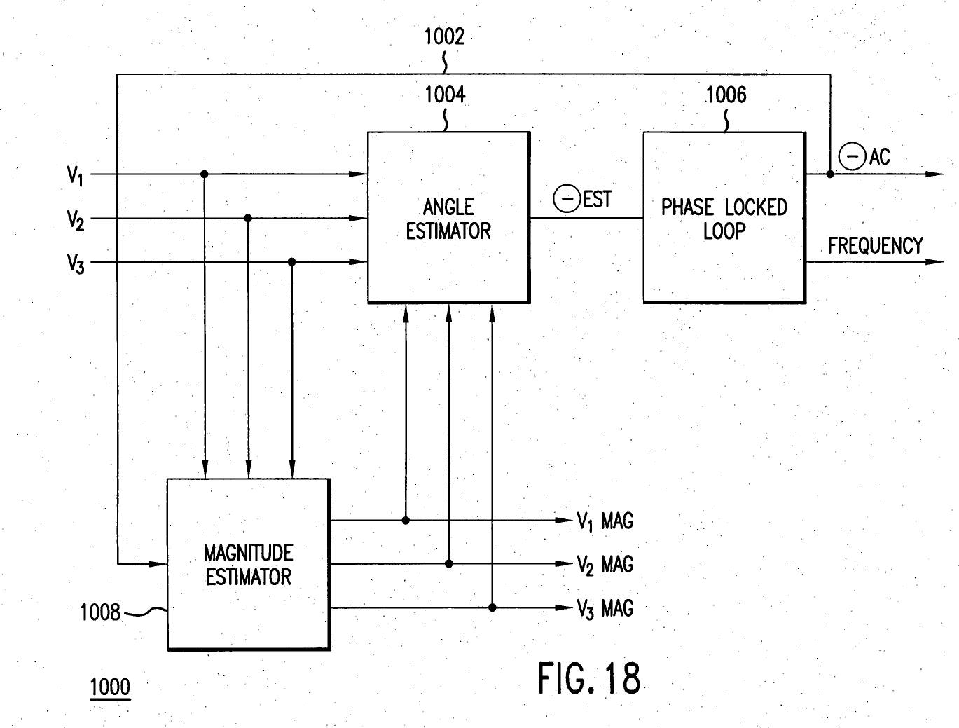

Referring to FIGS. 18-20, changes on load/utility grid 1050 are reflected as changes in the magnitude of the voltage. In particular, the type and seriousness of any fault or event on load/utility grid 1050 can be determined by magnitude estimator 1008, which monitors the magnitude and duration of any change on load/utility grid 1050.

The effect of voltage transients can be minimized by monitoring the current such that when it exceeds a predetermined level, switching is stopped allowing the current to decay, thereby preventing the current from exceeding its predetermined level. This embodiment takes advantage of analog over current detection circuits that have a faster response than transient detection based on digital sampling of current and voltage. Longer duration transients indicate abnormal utility grid conditions. These must be detected so power controller 1044 can shut down in a safe manner. Algorithms used to operate power controller 1044 provide protection against islanding of power controller 1044 in the absence of utility-supplied grid voltage. Near short or near open islands are detected within milliseconds through loss of current control. Islands whose load is more closely matched to the power controller output will be detected through abnormal voltage magnitudes and frequencies as detected by magnitude estimator 1008.

In particular, referring to FIG. 20, power controller 1044 includes brake resistor 1056 connected across DC bus 1046. Brake resistor 1056 acts as a resistive load, absorbing energy when output converter 1048 output is turned off under the direction of output SP 824. In operation, when output converter 1048 output is turned off, power is no longer exchanged with load/utility grid 1050, but power is still being received from turbogenerator 1040, which power is then absorbed by brake resistor 1056. The power controller 1044 detects the DC voltage on DC bus 1046 between motor/generator converter 1042 and output converter 1048. When the voltage starts to rise, brake resistor 1056 is turned on to allow it to dissipate energy.

In one configuration, Motor/generator 1040 produces three phases of AC at variable frequencies. Motor/generator converter 1042, under control of SP 1054, converts the AC from motor/generator 1040 to DC which is then applied to DC bus 1046 (regulated for example at 800vDC) which is supported by capacitor 1060 (for example, at 800 microfarads with two milliseconds of energy storage). Output converter 1048, under control of SP 1052, converts the DC on DC bus 1046 into three-phase AC, and applies it to load/utility grid 1050.

Current from DC bus 1046 can by dissipated in brake resistor 1056 via modulation of switch 1058 operating under the control of motor/generator SP 1054. Switch 1058 may be an IGBT switch, although other conventional or newly developed switches may be utilized as well.

Motor/generator SP 1054 controls switch 1058 in accordance to the magnitude of the voltage on DC bus 1046. The bus voltage of DC bus 1046 is typically maintained by output converter 1048, under the direction of output SP 1052, which shuttles power in and out of load/utility grid 1050 to keep DC bus 1046 regulated at, for example, 800v DC. When output converter 1052 is turned off, it no longer is able to maintain the voltage of DC bus 1046, so power coming in from motor/generator 1040 causes the bus voltage of DC bus 1046 to rise quickly. The rise in voltage is detected by motor/generator SP 1054, which turns on brake resistor 1058 via switch 1058 and modulates it on and off until the bus voltage is restored to its desired voltage, for example, 800 VDC. Output SP 1052 detects when the utility grid transient has dissipated, i.e., AC current has decayed to zero and restarts output converter 1048 of power controller 1044. Brake resistor 1056 is sized so that it can ride through the transient and the time taken to restart output converter 1048.

Referring to FIGS. 18 and 20, both the voltage and zero crossings (to determine where the AC waveform of load/utility grid 1050 crosses zero) are monitored to provide an accurate model of load/utility grid 1050. Utility grid analysis system 1000 includes angle estimator 1004, magnitude estimator 1008 and phase locked loop 1006. The system 1000 continuously monitors utility grid voltage and based on these measurements, estimates the utility grid angle, thus facilitating recognition of under/over voltages and sudden transients. Current limits are set to disable output converter 1048 when current exceeds a maximum and wait until current decays to an acceptable level. The result of measuring the current and cutting it off is to allow output converter 1048 to ride through transients better. Thus when DC/AC converter 1048 is no longer exchanging power with utility grid 1050 power is dissipated in brake resistor 1058.

Output SP 1052 is capable of monitoring the voltage and current at load/utility grid 1050 simultaneously. In particular, power controller 1044 includes a utility grid analysis algorithm. Estimates of the utility grid angle and magnitude may be derived via conventional algorithms or means. The true utility grid angle θAC, which is the angle of the generating source, cycles through from 0 to 2π and back to 0 at a rate of 60 hertz. The voltage magnitude estimates of the three phases are designated V1 mag, V2 mag and V3 mag and the voltage measurement of the three phases are designated V1, V2 and V3.

A waveform, constructed based upon the estimates of the magnitude and angle for each phase, indicates what a correct measurement would look like. For example, using the first of the three phase voltages, the cosine of the true utility grid angle θAC is multiplied by the voltage magnitude estimate V1 mag, with the product being a cosine-like waveform. Ideally, the product would be voltage measurement V1.

Feedback loop 1002 uses the difference between the absolute magnitude of the measurement of V1 and of the constructed waveform to adjust the magnitude of the magnitude estimate V1 mag. The other two phases of three-phase signal can be adjusted similarly, with different angle templates corresponding to different phases of the signal. Thus, magnitude estimate V1 mag and angle estimate θEST are used to update magnitude estimate V1 mag. Voltage magnitude estimates V1 mag, V2 mag and V3 mag are steady state values used in a feedback configuration to track the magnitude of voltage measurements V1, V2 and V3. By dividing the measured voltages V1 by the estimates of the magnitude V1 mag, the cosine of the angle for the first phase can be determined (similarly, the cosine of the angles of the other signals will be similarly determined).

The most advantageous estimate for the cosine of the angle, generally the one that is changing most rapidly, is chosen to determine the instantaneous measured angle. In most cases, the phase that has an estimate for the cosine of an angle closest to zero is selected since it yields the greatest accuracy. Utility grid analysis system 1000 thus includes logic to select which one of the cosines to use. The angle chosen is applied to angle estimator 1004, from which an estimate of the instantaneous angle θEST of load/utility grid 60 is calculated and applied to phase locked loop 1006 to produce a filtered frequency. The angle is thus differentiated to form a frequency that is then passed through a low pass filter (not shown). Phase locked loop 1006 integrates the frequency and also locks the phase of the estimated instantaneous angle θEST, which may have changed in phase due to differentiation and integration, to the phase of true utility grid angle θAC.

In one mode of operation, when the phase changes suddenly on measured voltage V1, the algorithm compares the product of the magnitude estimate V1 mag and the cosine of true utility grid angle θAC against the real magnitude multiplied by the cosine of a different angle. A sudden jump in magnitude would be realized.

Thus, three reasonably constant DC voltage magnitude estimates are generated. A change in one of those voltages indicates whether the transient present on load/utility grid 1050 is substantial or not. There are a number of ways to determine whether a transient is substantial or not, i.e., whether abnormal conditions exist on the utility grid system, which require power controller 1044 to shut down. A transient can be deemed substantial based upon the size of the voltage magnitude and duration. Examples of the criteria criterion for shutting down power controller 1044 are shown in FIG. 19. Detection of abnormal utility grid behavior can also be determined by examining the frequency estimate.

On detecting abnormal utility grid behavior, a utility grid fault shutdown is initiated. When system controller 1044 initiates a utility grid fault shutdown, output contactor 774, shown in FIG. 10, is opened within a predetermined period of time, for example, 100 msec, and fuel cutoff solenoids 742 are closed, removing fuel from turbogenerator 782. A warm shutdown ensues during which control power is supplied from motor/generator 778 as it slows down. In one configuration, the warm-down lasts about 1-2 minutes before the rotor (not shown) is stopped. The control software does not allow a restart until utility grid voltage and frequency are within permitted limits.

Having now described the embodiments above in accordance with the requirements of the patent statutes, those skilled in this art will understand how to make changes and modifications in the present invention to meet their specific requirements or conditions. For example, the power controller, while described generally, may be implemented in an analog or digital configuration. In one digital configuration, one skilled in the art will recognize that various terms utilized in the invention are generic to both analog and digital configurations of power controller. For example, converters referenced in the present application is a general term which includes inverters, signal processors referenced in the present application is a general term which includes digital signal processors, and so forth. Correspondingly, in a digital implementation of the present invention, inverters and digital signal processors would be utilized. Such changes and modifications may be made without departing from the scope and spirit of the invention as set forth in the following claims.

Having now described the invention in accordance with the requirements of the patent statutes, those skilled in this art will understand how to make changes and modifications in the present invention to meet their specific requirements or conditions. Such changes and modifications may be made without departing from the scope and spirit of the invention as set forth in the following claims.

What is claimed is:

1. A power controller for distributing power among a plurality of energy components, comprising:
a DC bus; and
a plurality of power converters, each of which is connected between one of said energy components and said DC bus and is responsive to said power controller, wherein said power controller provides a distributed generation power system by controlling the way each energy component sinks or sources power and said DC bus is regulated.
